(19) United States
(12) Patent Application Publication
(10) Pub. No.: US 2002/0082860 A1
(43) Pub. Date: Jun. 27, 2002

(54) Method and system for generating automated quotes and for credit processing

(76) Inventor: Ken Johnson, Eden Prairie, MN (US)

Correspondence Address: Daniel G. Chapik, DORSEY & WHITNEY LLP, Suite 1500, 50 South Sixth Street, Minneapolis, MN, 55402-1498, US

(21) Appl. No.: 09/991,255

(22) Filed: Nov. 16, 2001

Related U.S. Application Data
(63) Continuation of application No. PCT/US00/32125, filed on Nov. 22, 2000.
(60) Provisional application No. 60/167,084, filed on Nov. 23, 1999.

(51) Int. Cl. G06F 17/60

(52) U.S. Cl. 705/1

(57) ABSTRACT

The present invention relates to a method and system for leasing a vehicle, including the generation of a quote for a leased vehicle and the generation of a credit report for the lessee. The invention may utilize a user interface, a server, and a communication pathway to electronically solicit, receive, store, and compute leasing and credit information, and generate reports and documentation.

### FIELD

This invention relates to a method and system for providing automated quotes for leases and loans and/or for a method and system for providing automated credit scoring for a lease or loan. More particularly, the invention relates to a method and system for providing real quotes for a vehicle, auto, or equipment lease or loan. In addition, the invention relates to a method and system for providing automated credit scoring and processing for a lease for a vehicle, auto, or piece of equipment. The method and system of the invention may use the Internet and computer hardware and software.

### BACKGROUND

In order to lease a piece of equipment, such as a vehicle, a lessee typically visits a dealer of the equipment and arranges for certain of the terms for a lease of the piece of equipment. The dealer, who typically is not the lessor of the equipment, may then arrange for the lease with a lessor of the equipment, which may be a financing company or a company that arranges for leases for a large number of entities. This party, the lessor of the equipment, may then arrange for a lease of the equipment. Although this invention is applicable to any type of equipment that may be leased, the specific embodiments of this invention detailed below relate to vehicle leases.

The lessor of a vehicle may arrange for a number of functions in order to effect a vehicle lease. These functions include: (1) generating a quote for the lease, (2) generating and processing a credit application for the lease, (3) documenting the lease, (4) funding the lease, and (5) generating reports for the lease. These functions are typically carried out through facsimile, mailing, and human processing of documents. For instance, in order for the lessor to generate a quote for a vehicle (such as a monthly payment over a certain number of months), the dealer will work out a price for a specific vehicle, a residual value, a length of the lease, and fees, such as a dealer fee and a documentation fee. After this information has been transmitted to the lessor, the lessor may process the information and transmit the specific payment terms for the lease to the dealer. In order to generate the specific payment terms for the lease, the lessor may need to consider the amount of money it will make off the lease (a profit margin), which may be driven by lending rates (interest rate charged to the lessee of the vehicle) and borrowing rates (interest rate charged by a lender to the lessor of the vehicle), by the class of vehicle, by specific options for the vehicle, or by a number of other factors that the lessor may consider to be important. FIG. 2 shows one embodiment of the typical process for generating quotes, requesting and processing credit applications, documenting a lease, and funding for the lease.

Processing credit applications for lessees is typically a time-consuming and costly process that has, in the past, required significant amounts of human intervention. After a lessee of a vehicle has reviewed the quote and decided to lease the vehicle, the lessee may fill out a credit application. This credit application may then be mailed or sent via facsimile to the lessor, who determines the credit worthiness of the lessee-applicant. Such credit scoring may be further complicated in the case of leases of fleets of vehicles, where a corporate entity will make lease payments, but where an employee of the corporate entity will drive the vehicle. In such a case, the credit worthiness of both the corporate entity and the individual employee may be scored.

If the lessee successfully passes the credit check, specific documents to accomplish the lease may need to be generated, completed by the lessee and dealer, and then sent to the lessor. After the transaction has been documented, funding for the lease may be carried out, and then reports for the lease may be generated.

The typical process outlined above for processing a quote and credit check for a lease has a number of disadvantages. At the very least, it takes a large amount of time, perhaps on the order of several days, to complete the quote, credit check, and documentation process for the lease. Additionally, a significant amount of time and human intervention may be required by the lessor to generate quotes, perform credit scoring, and generate documents for leases. This time and human intervention leads to inefficiencies that may result in high transaction costs for the lessor. In addition, the time delay may be annoying to the lessee and dealer of the vehicle, and may lead to lost leases due to time delays.

A need exists for an automated quoting system and method that may generate accurate quotes for leases in a short amount of time, that is convenient, and that is simple to use. A need also exists for an automated credit scoring and processing method and system that is easy to use, quick, efficient, and that decreases the amount of human intervention required to approve a credit application. Furthermore, a need exists for a method and system for automating the generation of documentation for leases. Because the dealer of a vehicle typically chooses the financing company or lessor, a lessor can generate more business by providing for a simple, efficient quoting and credit system that saves the dealer time and energy in closing a deal.

### SUMMARY

One embodiment of the invention is a method for generating a quote for a piece of leased equipment. This embodiment of the invention comprises electronically soliciting from a client terms for a lease for the piece of leased equipment, including a cost and residual value for the piece of leased equipment, term for the lease, and down payment information; electronically receiving and storing in a server the terms for the lease; computing payment terms for the lease based on the terms of the lease and a desired rate of return for the lease or specific lending and borrowing interest rates; and generating a report at the client showing the payment terms for the lease.

Another embodiment of the invention is a method for generating a credit report for a lessee of a piece of leased equipment. In this embodiment, the method comprises electronically soliciting from a client basic identification information, including identification information for an individual user of the piece of leased equipment and for a business lessee of the piece of leased equipment, receiving and storing in a server the client basic identification information, scoring the lessee's credit using external credit checking databases, and providing a credit report to the client detailing a credit score for the lessee. Another embodiment may combine the automated quoting process with the method for generating a credit report.

The invention offers numerous advantages over prior art methods and systems. In addition to substantial time savings to the lessor in processing documents, the system and method of the invention makes the lessor's services more attractive to vehicle dealers because of the simplicity and increased time savings offered by the invention. Instead of taking days to complete and document a lease, the automatic quoting, credit scoring, and document generation of the invention may offer significant time savings that make the lessor's services more attractive in comparison to competing lessors.

### DESCRIPTION OF THE DRAWINGS

FIG. 1 is a block diagram overview of a client-server system in which the present invention functions;

FIG. 2 is a process flow chart illustrating the typical process for generating quotes and for scoring credit applicants;

FIG. 3 is a flow chart showing one embodiment of the invention;

FIG. 4 is a flow chart showing one embodiment of a credit application and approval process;

FIG. 5 is a flow chart showing one embodiment of a credit approval process of the invention;

FIG. 6 is a flow chart showing one embodiment of a documentation process of the invention;

FIG. 7 is a flow chart showing a second embodiment of a documentation process of the invention;

FIG. 8 is a block chart of the inputs, calculations, and interest rates used in one embodiment of a quote generation process of the invention;

FIG. 9 is diagram of a web page for a main menu of an embodiment of the invention;

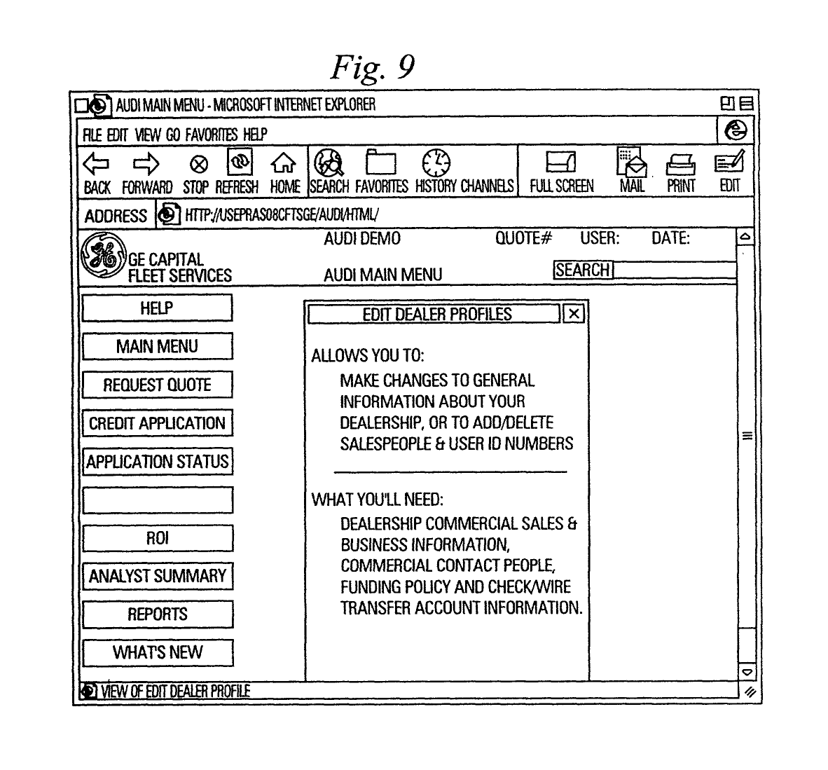

FIG. 10 is diagram of a web page for use at the client computer for entering information to request a quote;

FIG. 11 is diagram of a second web page for use at the client computer for entering information to request a quote;

FIG. 12 is diagram of a web page for use at the client computer for entering customer information for a credit application;

FIG. 13 is diagram of a web page for use at the client computer for entering owner information for a credit application;

FIG. 14 is diagram of a web page for use at the client computer for entering creditor information for a credit application;

FIG. 15 is diagram of a web page for use at the client computer for entering insurance information for a credit application;

FIG. 16 is diagram of a web page for use at the client computer for entering Y2K and hazards information for a credit application;

FIG. 17 is diagram of a web page for use at the client computer for entering signature information for a credit application;

FIG. 18 is diagram of a web page for use at the client computer for checking on the status of credit applications;

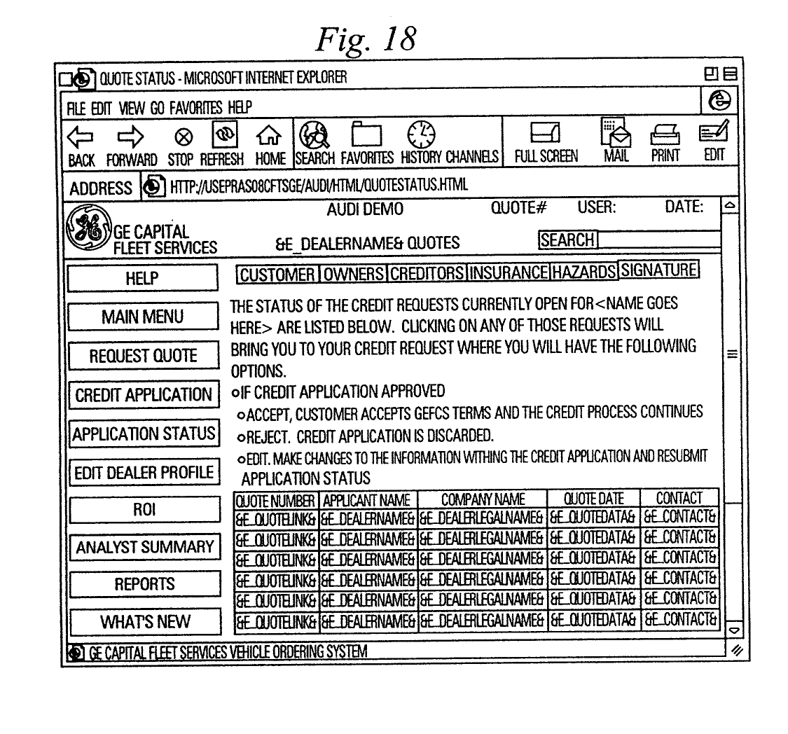

FIG. 19 is diagram of a web page for use at the client computer for entering dealer information for a dealer profile;

FIG. 20 is diagram of a web page for use at the client computer for entering contacts information for a dealer profile;

FIG. 21 is diagram of a web page for use at the client computer for entering sales information for a dealer profile;

FIG. 22 is diagram of a web page for use at the client computer for entering funding information for a dealer profile;

FIG. 23 is diagram of a web page for use at the client computer for entering dealer information for an internal quote request;

FIG. 24 is diagram of a web page for use at the client computer for entering vehicle information for an internal quote request;

FIG. 25 is diagram of a web page for use at the client computer for entering contributed value information for an internal quote request;

FIG. 26 is diagram of a web page for use at the client computer for entering terms information for an internal quote request;

FIG. 27 is diagram of a web page for use at the client computer for entering approvals information for an internal quote request;

FIG. 28 is diagram of a web page for use at the client computer for entering summary information for an analyst summary;

FIG. 29 is diagram of a web page for use at the client computer for entering customer information for an analyst summary;

FIG. 30 is diagram of a web page for use at the client computer for entering business information for an analyst summary;

FIG. 31 is diagram of a web page for use at the client computer for entering principal information for an analyst summary;

FIG. 32 is diagram of a web page for use at the client computer for entering collateral information for an analyst summary;

FIG. 33 is diagram of a web page for use at the client computer for entering dealer information for an analyst summary;

FIG. 34 is diagram of a web page for use at the client computer for entering documents information for an analyst summary;

FIG. 35 is diagram of pricing model and summary sheet that may be used in an automated quoting embodiment of the invention; and

FIG. 36 is diagram of an embodiment of a lease proposal that may be used to transmit a quote to a dealer.

### DETAILED DESCRIPTION

One embodiment of the invention allows a user, such as a vehicle dealer, to enter certain information about the lease of a vehicle in a client computer and then have a quote automatically generated using a client-server system. In addition, the user may also enter certain credit information about the prospective lessee, and the lessee's credit may be scored for approval or denial automatically over the client-server system. In addition, paperwork to close a lease transaction may be automatically generated upon credit approval. Such paperwork may be available through the client-server system of the invention.

The teachings of the present invention are applicable to many different types of computer networks and may also be used, for instance, in conjunction with direct on-line connections to databases. As will be appreciated by those of ordinary skill in the art, while the following discussion sets forth various preferred implementations of the method and system of the present invention, these implementations are not intended to be restrictive of the appended claims, nor are they intended to imply that the claimed invention has limited applicability to one type of computer network or one type of user. While the principles underlying the Internet and the Web are described in some detail below in connection with various aspects of the present invention, this discussion is provided for descriptive purposes only and is not intended to imply any limiting aspects to the methods and systems of the present invention.

The Internet is widely used today for a variety of applications. The Internet is a collection of computer networks that allows computer users to share files and other computer resources. Each computer connected to the Internet has a unique address whose format is defined by the Internet Protocol (“TCP/IP”). The Internet includes a public network using the TCP/IP and includes two kinds of computers: servers, which provide information and documents; and clients, which retrieve and display documents and information for users. As will be appreciated by those of ordinary skill in the art, as used throughout this specification the term “client” refers to a client computer (or machine) on a network, or to a process or programs, such as Web browsers, which run on a client computer in order to facilitate network connectivity and communications. This specification will use the term “individual” or “user” when referring to a person using a client computer to access the server and enter usage information. Similarly, the term “server” will be used throughout this specification to refer to a server computer or computer system on a network, including the database attached to the server for storing information.

The “World Wide Web” (“Web” or “WWW”) is that collection of servers on the Internet that utilize the Hypertext Transfer Protocol (“HTTP”). HTTP is a known application protocol that provides users access to resources, which may be information in different formats such as text, graphics, images, sound, video, Hypertext Markup Language (“HTML”), as well as programs. HTML is a standard page description language which provides basic document formatting and allows the developer to specify “links” to other servers and files. Links may be specified via a Uniform Resource Locator (“URL”). Upon specification of a link by the user, the client makes a TCP/IP request to a Web server and receives information, which may be another “Web page” that is formatted according to HTML. Users can also access other pages on the same or other servers by following instructions on the screen, entering certain data, or clicking on selected icons.

Servers run on a variety of platforms, including UNIX machines, although other platforms, such as Windows 95, Windows NT, and Macintosh may also be used. Computer users can view information available on servers or networks on the Web through the use of browsing software, such as Netscape, Microsoft Internet Explorer, Mosaic, or Lynx browsers. A typical Web page is an ITFML document with text, “links” that a user may activate (e.g. “click on”), as well as embedded URL's pointing to resources, such as images, video or sound, that the client may activate to fully use the Web page in a browser. Furthermore, icons may be present which a user clicks on to submit usage information to the server, or to request information from the server. In some situations, these resources may not be located on the same server that provided the HTML document to the client. Furthermore, HTTP allows for the transmission of certain information from the client to a server. The server can then post this information on its web site, forward it on to another user or server, or save it to a database for later use.

The accompanying Figures depict features and components of the methods and systems of the present invention. With regard to references in this specification to computers, the computers may be any standard computer including standard attachments and components thereof (e.g., a disk drive, hard drive, CD player or network server that communicates with a CPU and main memory, a sound board, a keyboard and mouse, and a monitor). The processor of the CPU in the computer may be any conventional general purpose single- or multi-chip microprocessor such as a Pentium® processor, a Pentium® Pro processor, a 8051 processor, a MIPS® processor, a Power PC® processor, or an ALPHA® processor. In addition, the processor may be any conventional special purpose processor such as a digital signal processor or a graphics processor. The microprocessor has conventional address lines, conventional data lines, and one or more conventional control lines. With regard to references to software, the software may be standard software used by those skilled in the art or may be coded in any standard programming language to accomplish the tasks detailed below.

A. General Overview

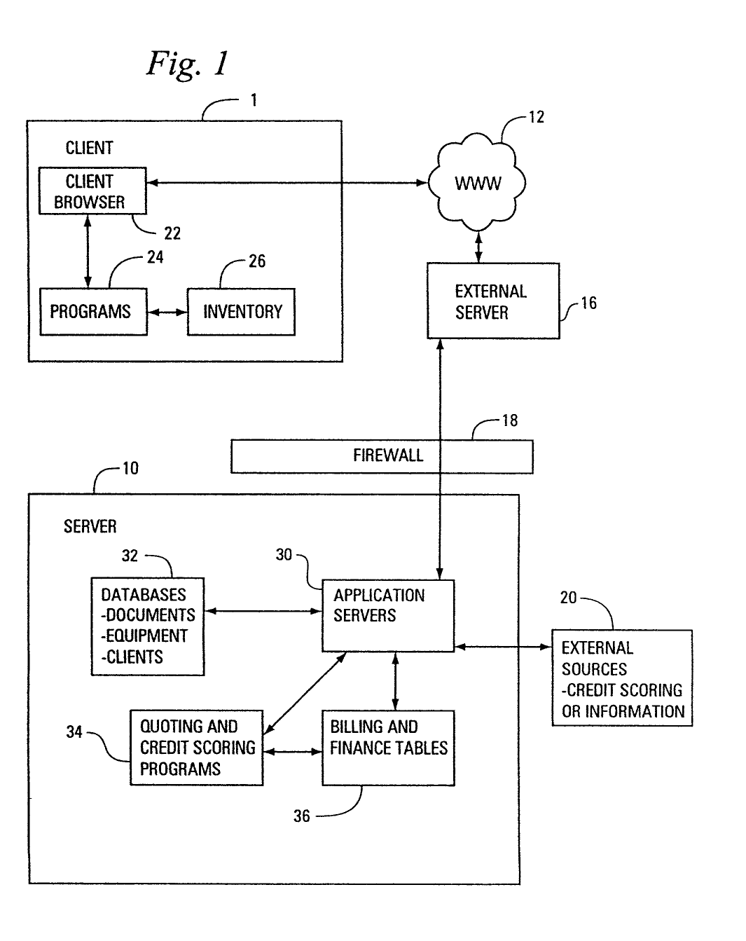

FIG. 1 is a block diagram illustration of the environment of one embodiment of the present invention, which is a network based on a client-server model. The network comprises one or more servers 10 which are accessible by one or more clients 14, such as personal computers or telephones. FIG. 1 illustrates a user interface device as the client 14, which may be either a client computer, a touch tone telephone, or another interface device known to those skilled in the art. The servers 10 communicate with the client 14 over a communication path 12, which may be a direct dial connection, the Internet or World Wide Web (“WWW”), or other suitable telecommunications path. A suitable network protocol, such as the TCP/IP protocol, may be used for the communications. Communications may also be done in one embodiment by voice interactive technology known in the art or by pushbutton commands.

The servers 10 may comprise Web servers and application servers, and may be any computer known to those skilled in the art. The Web server and the application server can be separate entities, or may exist within a single computer or computer system. This specification will refer to both possibilities as server 10. The server 10 allows access by the clients 14 to various network resources. FIG. 1 also illustrates an external server 16, which may be a separate computer from the server 10. In FIG. 1, this external server 16 is separated from the server 10 by a firewall 18. The firewall 18 protects the server 10 from the WWW and may be any common or custom firewall known to those skilled in the art. The server 10 may also have access, via direct dial or the Internet, to external data sources 20, such as credit scoring information. It is to be understood that any number of clients 14 may be connected to the server 10 at any given time, and therefore a number of dealers (using clients 14 at remote locations) may access and use the server 10 in order to carry out the invention.

1. The Client-Side

The client 14 may be a client computer, which may be any computer or computers used by those skilled in the art. The client computer 14 comprises a central processor unit (“CPU”) and main memory, an input/output interface for communicating with various databases, files, programs, and networks (such as the Internet), and one or more storage devices. The storage devices may be disk drive devices or CD ROM devices. The client computer 14 may also have a monitor or other screen device and an input device, such as a keyboard or a mouse. In order to carry out the present invention over the Internet, the client computer 14 may also have some software programs contained in the main memory or the storage devices which can be used by the CPU.

In one embodiment of the present invention, the client browser 22 is a Web browser, which is a known software tool used to access the Web via a connection obtained through an Internet access provider, may be part of the software programs on the client computer 14. A variety of browsers known to those skilled in the art may be used within the scope of the present invention, including Netscape Navigator, Microsoft Internet Explorer, or Mosaic browsers. As explained above, a Web server may allow access to so-called “Web sites” and “Web pages.” Once the Web browser has accessed these pages through the Web server, the HTML page may be downloaded through the input/output interface. The central processing unit may use the browser software package to interpret the information and display it on the monitor.

The software programs 24 on the client computer 14 may also contain other software or programs which will allow the user to fill in information on the screens and to exchange data with the server 10. The programs 24 on the client computer 14 may also contain inventory and inventory control software 26 in order to track vehicle or leased equipment inventory.

2. The Server-Side

FIG. 1 shows a possible server configuration for the system and method of the invention. The server 10 contains software programs that run on the server-side to process requests and responses from the user's interface. In addition, the software programs may send information to the client computer 14, perform compilation and storage functions, and generate reports that may be used by either the client or the system administrator. If the Internet is the user's interface, then the server 10 may also send web pages in HTML format for the user to download and interpret with his/her computer and view on a monitor.

The server 10 may be set up in a variety of different formats to perform the functions of the invention. In FIG. 1, the server 10 contains application servers 30 to interface with the WWW and a number of databases 32, programs 34, and tables 36. The databases 32 may contain a variety of information, including various documents that may be used by the system and method of the invention, clients, and information on types of equipment or vehicles. The programs 34 may contain instructions, logic, and software that perform the quoting and credit scoring functions for the system and method of the invention. In one embodiment, a Microsoft Excel spreadsheet could be used to perform these functions. The table 36 may contain further information on the billing and finance aspects of the invention.

B. Operation of the Invention

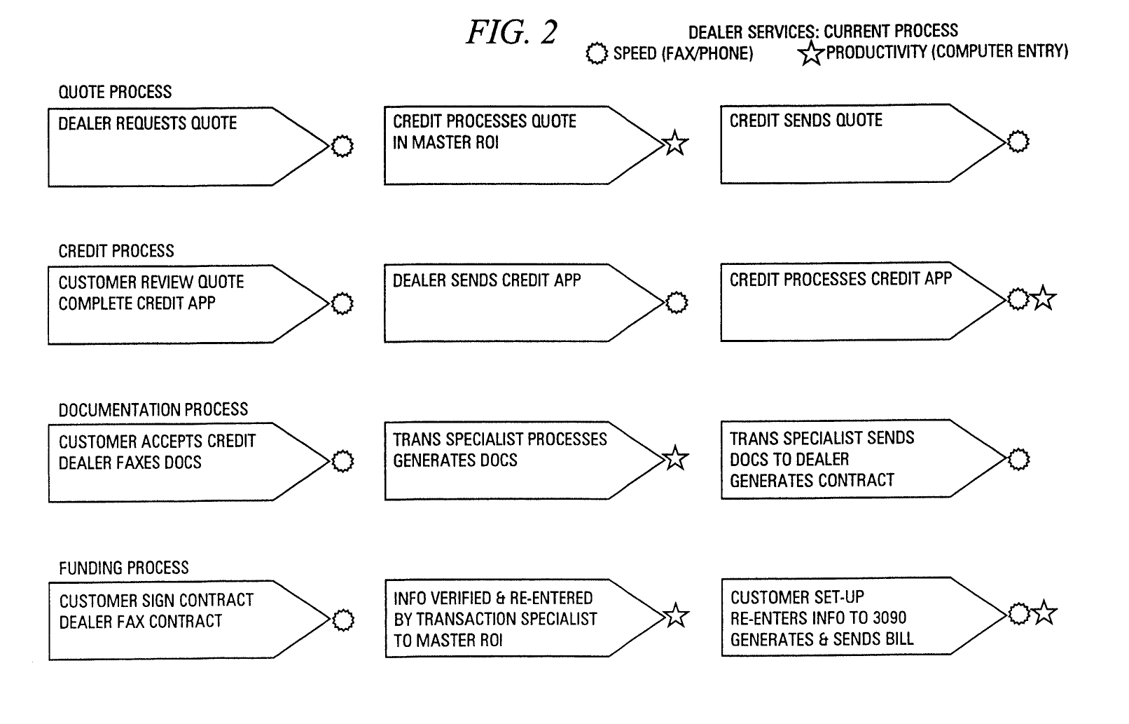

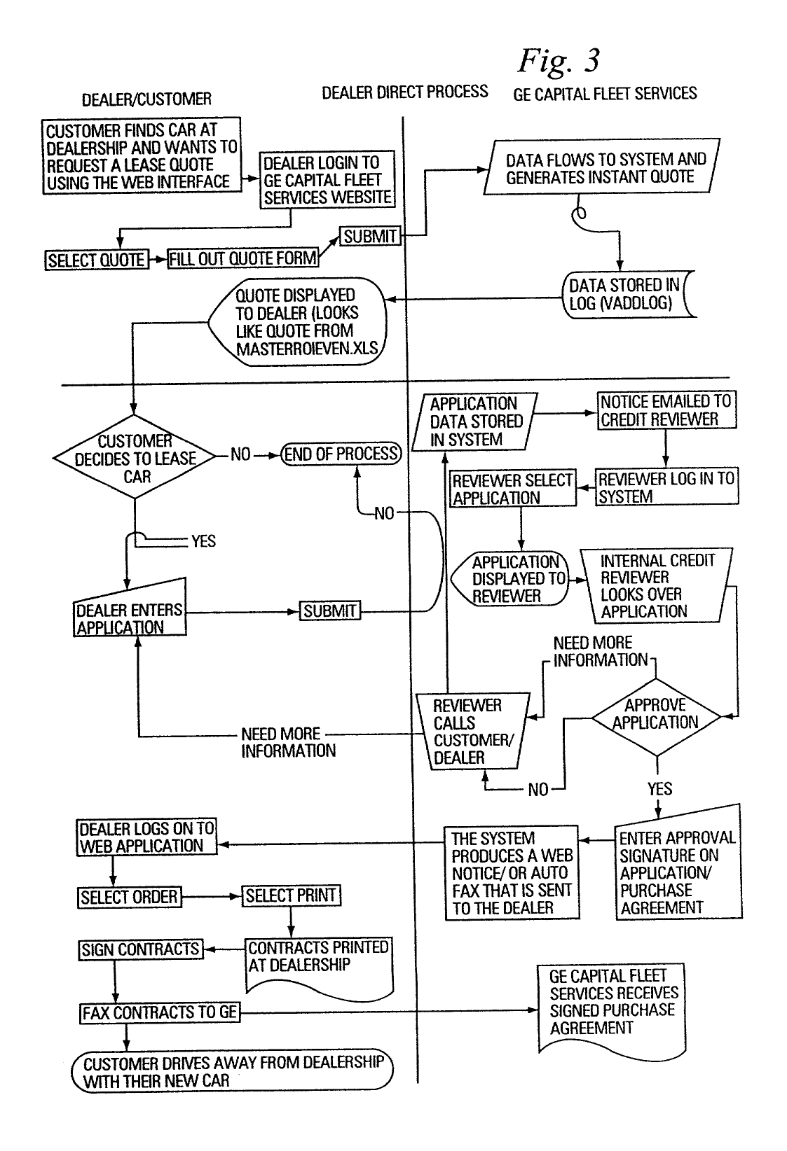

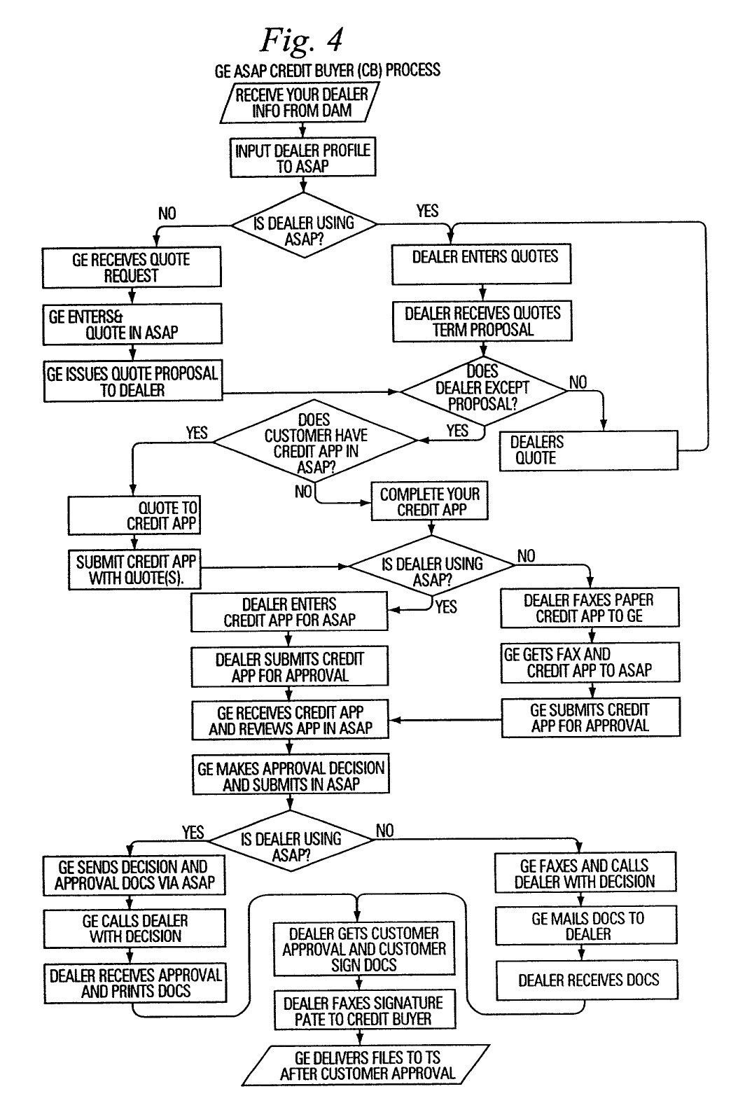

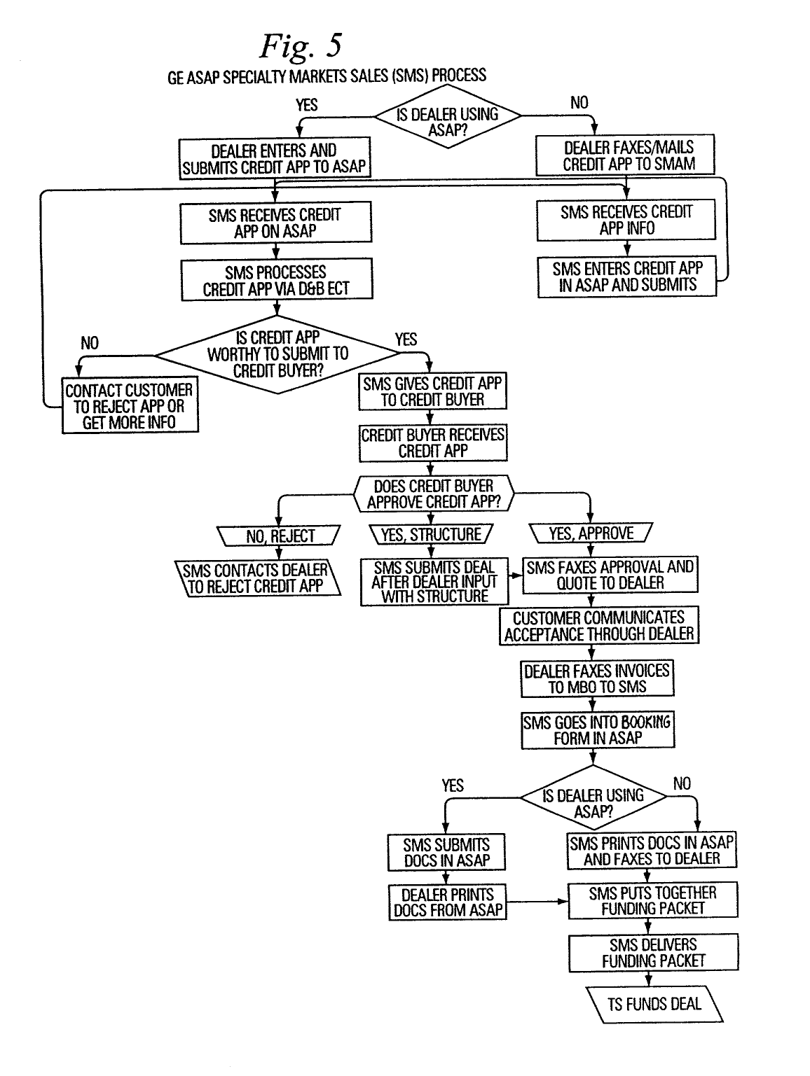

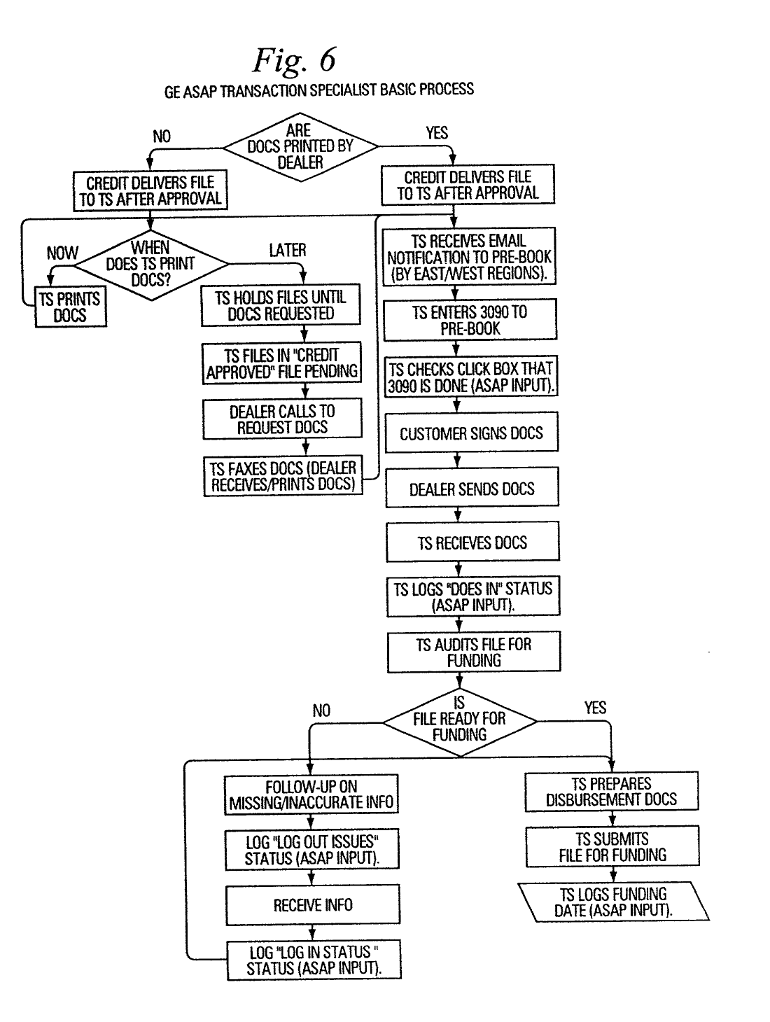

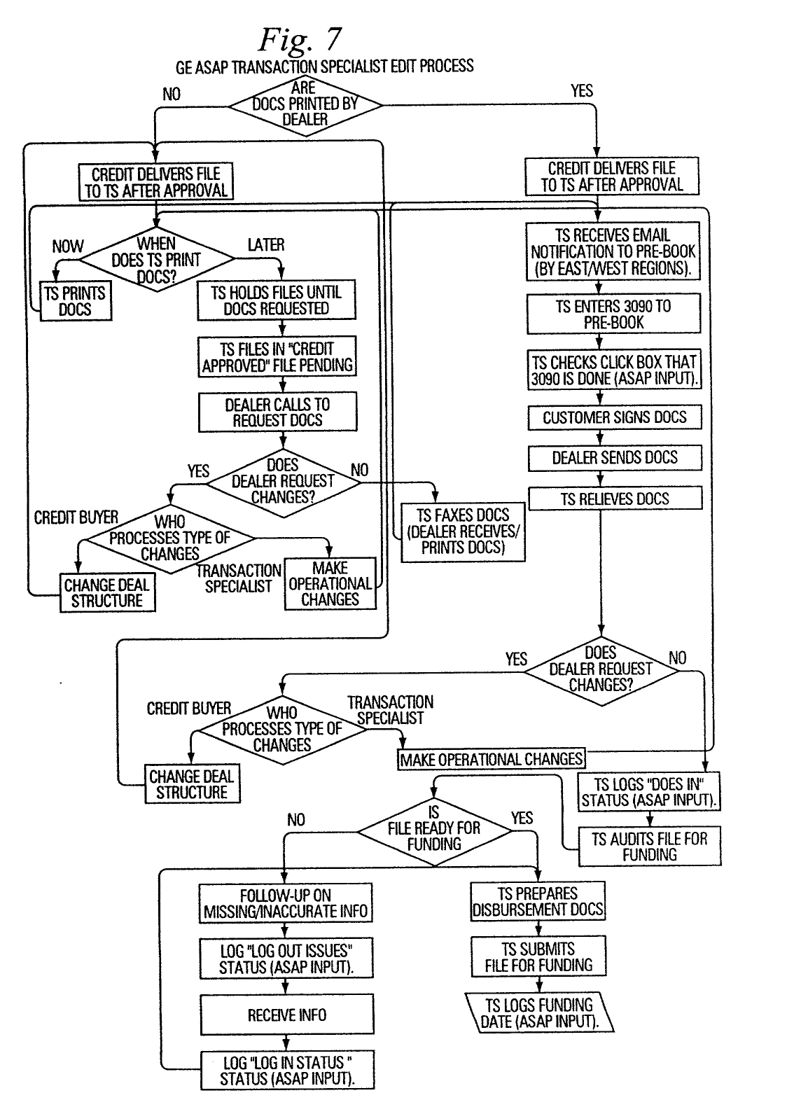

FIGS. 2-7 illustrate flow diagrams of various embodiments of the invention. FIG. 2 illustrates the typical process for generating quotes and for scoring credit applicants. FIG. 3 depicts various acts of the dealer/lessee and the lessor (GE Capital Fleet Services) in one embodiment of an automated quoting system and method of the invention. FIGS. 4-7 illustrate various other embodiments of the invention and include details on credit processing and scoring, and document generation. The system and method of the invention may use common database functions to sort and recognize different dealers, customers, lessees, and individual drivers. Password control may be used to restrict access to certain dealers, and only certain system administrators may have access to the programs of the invention to manipulate formulas or rates used in certain of the calculations of the invention.

1. Generating Quotes

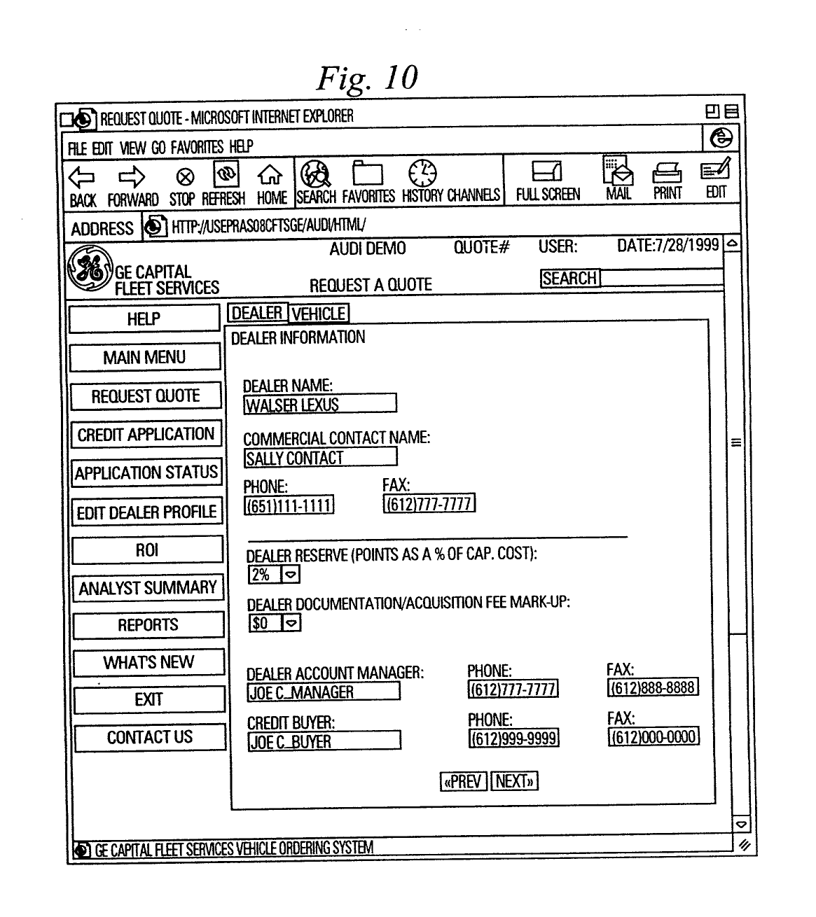

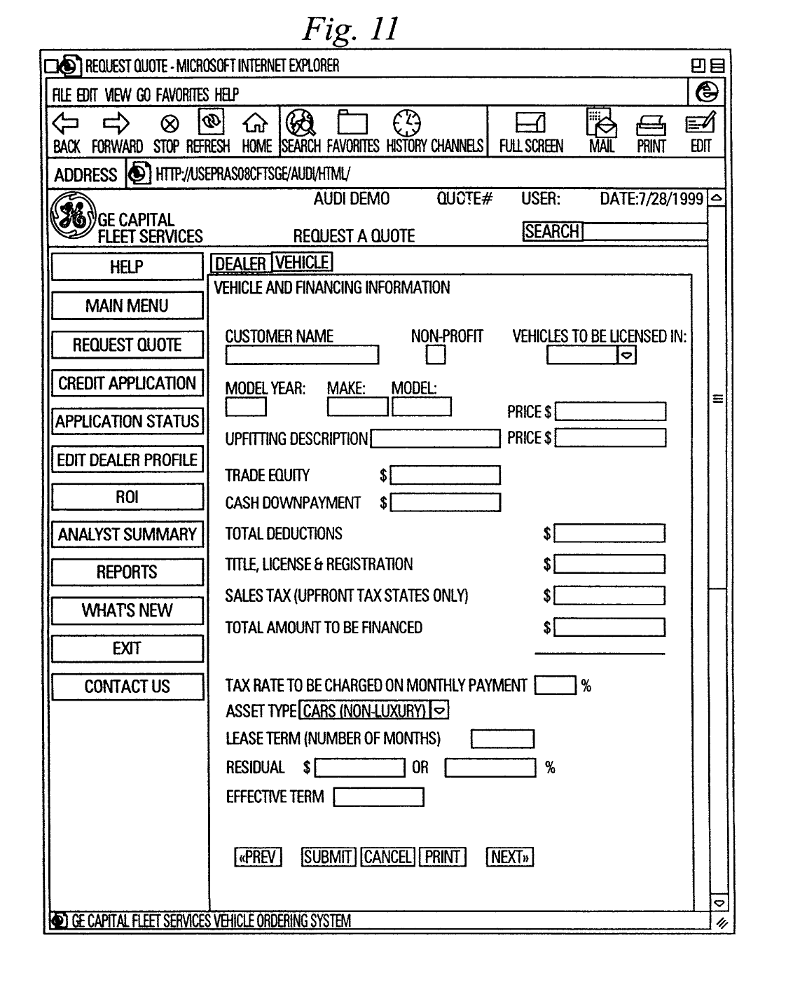

FIGS. 10 and 11 illustrate various information that a dealer can enter at the client computer in order to request a quote for a vehicle. In one embodiment, the information includes a dealer reserve for the lease (which may be a percentage of the capital cost of the vehicle), a dealer documentation fee, and other information as seen in FIG. 10. The information to request a quote may also include a make, model, and year of car, a price for the car along with an upfitting description, an asset type for the vehicle (such as non-luxury cars, luxury cars, light trucks, etc . . . ), a residual value for the lease, and a term for the lease. After a user has entered information into the web pages of FIGS. 10 and 11, the user can click “submit” to submit the information to the server 10.

In order to generate a quote for the lease, the lessor can use any internal model known to those skilled in the art to generate the payment terms for the lease. In one embodiment, the lessor may alter a lending interest rate, which is a rate of interest that the lessor charges the lessee for the lease. Depending on this lending interest rate, as well as the interest rate for which the lessor borrows money for its purchase of the vehicle, the lessor may determine the payment terms for the lease. In another embodiment, the lessor may look to the type of asset (or the type of vehicle), determine a desired profit for a lease of that vehicle, and then generate payment terms, including a lending rate to the lessee, based on the desired profit for the lease.

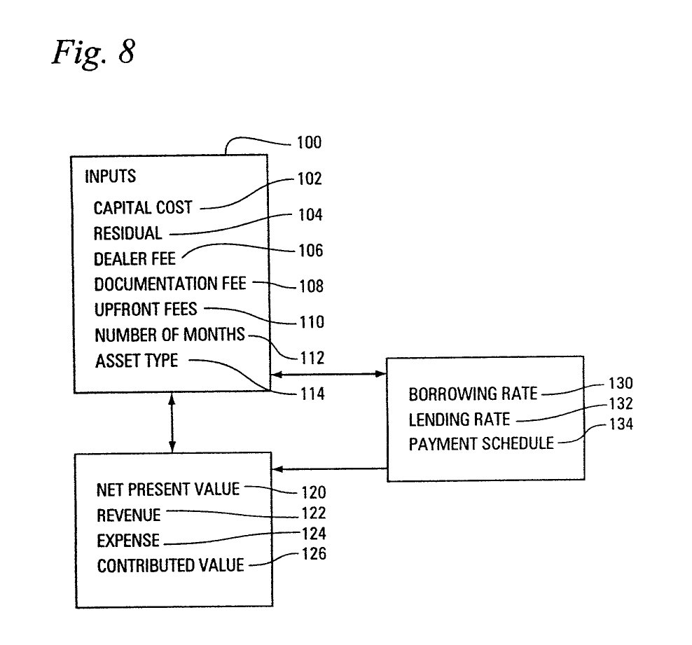

FIG. 8 depicts a number of the inputs 100 to a model for generating a quote for a vehicle. In the embodiment of FIG. 8, these inputs are the capital cost 102 of the vehicle (which may be determined by the dealer's negotiation with the lessee), the residual value 104 of the lease, the dealer's fee 106, the documentation fee 108, the up-front fees 110, the number of months for the lease 112, and the type of asset 114, which may include specific information about the make, model, and year of the vehicle, along with options for the vehicle. A number of other inputs may also be used for quote generation, including the information depicted in FIGS. 10 and 11.

FIG. 8 also shows some of the calculations that may be performed at the server 10 when determining the payment terms for a lease. Such information may include the net present value 120 of the lease, the revenue 122 expected during the lease, the expenses 124 expected during the lease, and the contributed value 126 for the lease. In one embodiment, present value calculations may be performed to determine the present value of revenue, expenses, and contributed value 126. The contributed value 126, which may be the profit margin that the lessor expects from the lease, may be calculated in any number of methods known to those skilled in the art based on borrowing 130 and lending rates 132, monthly payments, and any variety of the other types of information shown in FIGS. 8, 10, and 11. In one embodiment, as noted above, the server 10 may have desired contributed values for certain types of assets, or for certain makes or models of vehicles. In such situations, the lending rate 132 to the lessee may be altered depending on the desired contributed value for the lease (assuming the borrowing rate for the lessor is not negotiable). In such a situation, the contributed value 126 will not be calculated from fixed interest rates, but instead the interest rates may be determined by an expected contributed value for the deal. It should also be noted that the lessor may wish for the calculation of other provisions based on the lease, including amortization schedules (either straight line or accelerated), interest payments the lessor will have to make on the borrowed money for the lessor's purchase of the vehicle, cash flow numbers, and information on the principle remaining to be paid. A schedule for the lease may also be generated summarizing the information for the lease.

In one embodiment, a table may be generated containing the number of each month on one axis and a number of calculations on the other axis. Such calculations can include the remaining amount of the capital cost, the up-front fees, the security deposit, the payment and interest for each month, the expense for the lessor each month, tax factors, depreciation numbers, and various cash flow numbers, including a projected revenue cash flow for each month. In such an embodiment, the monthly payment may be based principally on the capital cost, residual value, lending rate, amortization schedule, and timing when payments will be made, and such a calculation may be carried out by any known accounting method known to those skilled in the art.

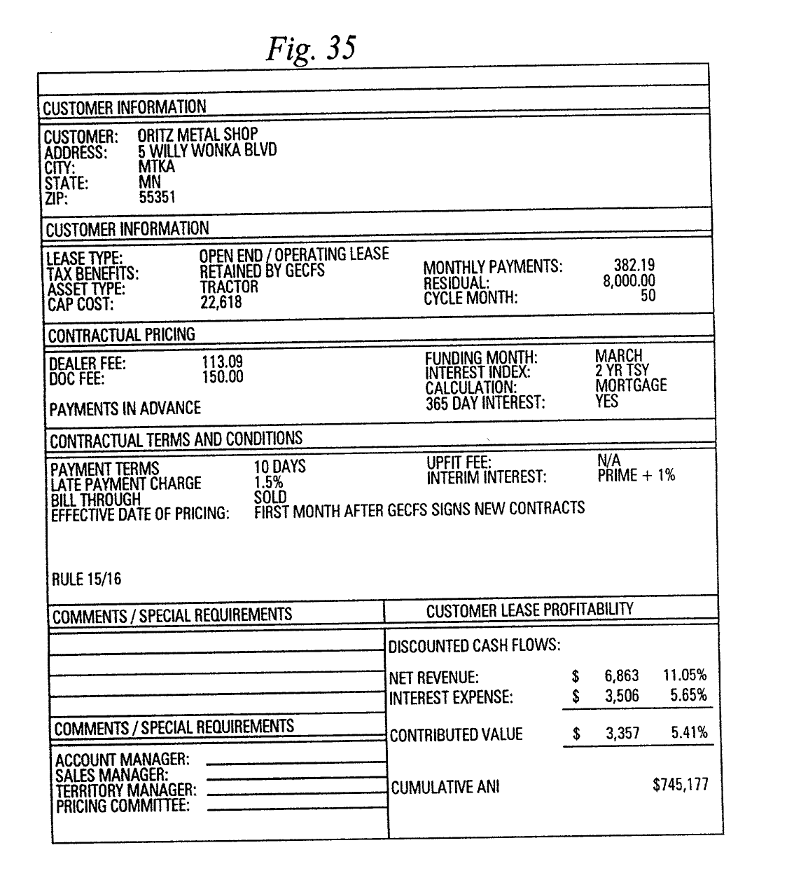

FIG. 35 illustrates one possible pricing model that may be used within the server 10 in one embodiment of the invention. FIG. 35 shows, from a lessor's standpoint, the net revenue expected for a lease, the interest expenses expected, the contributed value expected, as well as other information for the lease, including percentages for these calculations. FIG. 35 also shows other information for the terms of the lease, such as the capital cost, lease type, tax benefits, asset type, monthly payments, residual, and length of the lease.

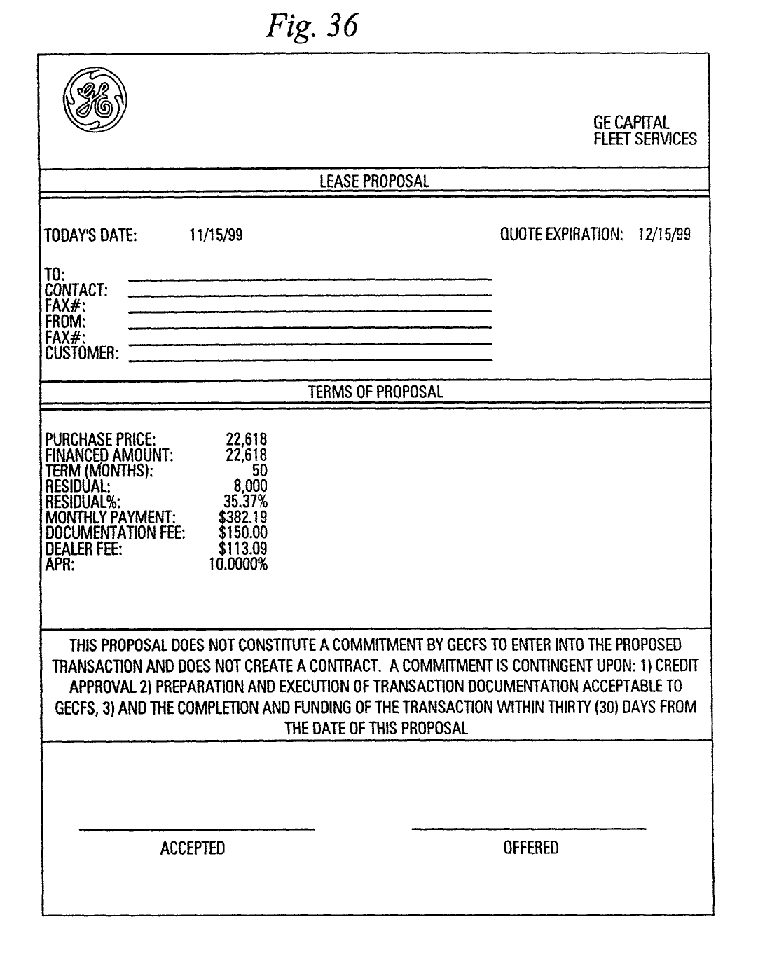

FIG. 36 illustrates one embodiment of a lease proposal that may be sent from the server 10 to the client computer 14 to present the terms of a lease to the lessee. In addition to the terms of the proposal, which include the purchase price, term of the lease, residual, residual percent, monthly payment, documentation fee, dealer fee, and interest rate for the lease, the proposal of FIG. 36 also contains signature lines and other information for the acceptance of the terms of the lease. In one embodiment, a proposal such as that in FIG. 36 may be automatically generated in the server 10 for transmission to the client computer 14 by the method and system of the invention.

Although the quoting method and system depicted above was described with specific references to leases, such a process could also be used for financing loans and/or for determining loan payments. In addition, the quoting system and method described above may, in one embodiment, offer accurate and final quotes instead of guideline quotes from which the lessor may deviate. In other words, the quotes automatically generated by the method and system of the invention may be real quotes to which the lessor is willing to be bound.

After a credit proposal has been transmitted to the client computer 14, the lessee or dealer may be given the option to accept the proposal, modify the proposal, reject the proposal, or hold the proposal. If modified or rejected, a different proposal may be automatically generated in one embodiment of the invention, perhaps using differing interest rates, length of lease, down payments, etc . . .

2. Credit Scoring and Processing

The method and system of the invention may offer automated credit scoring and processing in addition to quoting. The invention may, in one embodiment, be able to connect multiple quotes to one credit application. The invention may also, in one embodiment, alter the quote for a lease depending on the results of a credit check. Such risk-based pricing may be offered to increase the lessor's profit margin for leases for which the lessee is more likely to default than the average lessee.

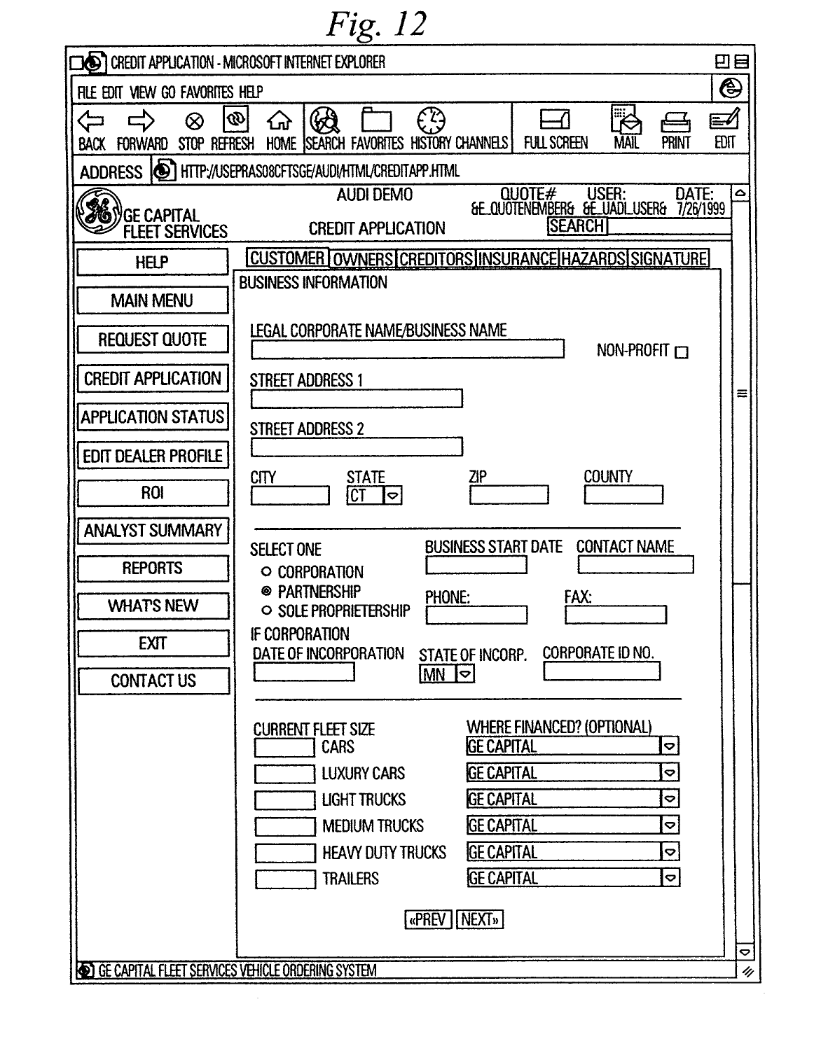

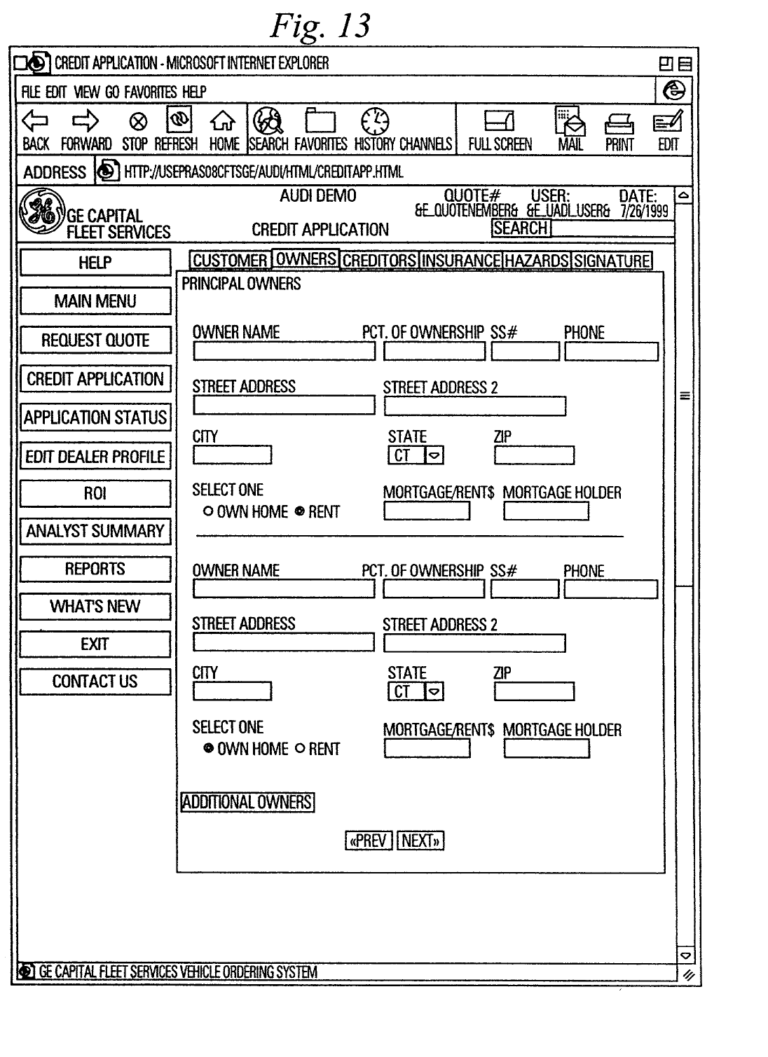

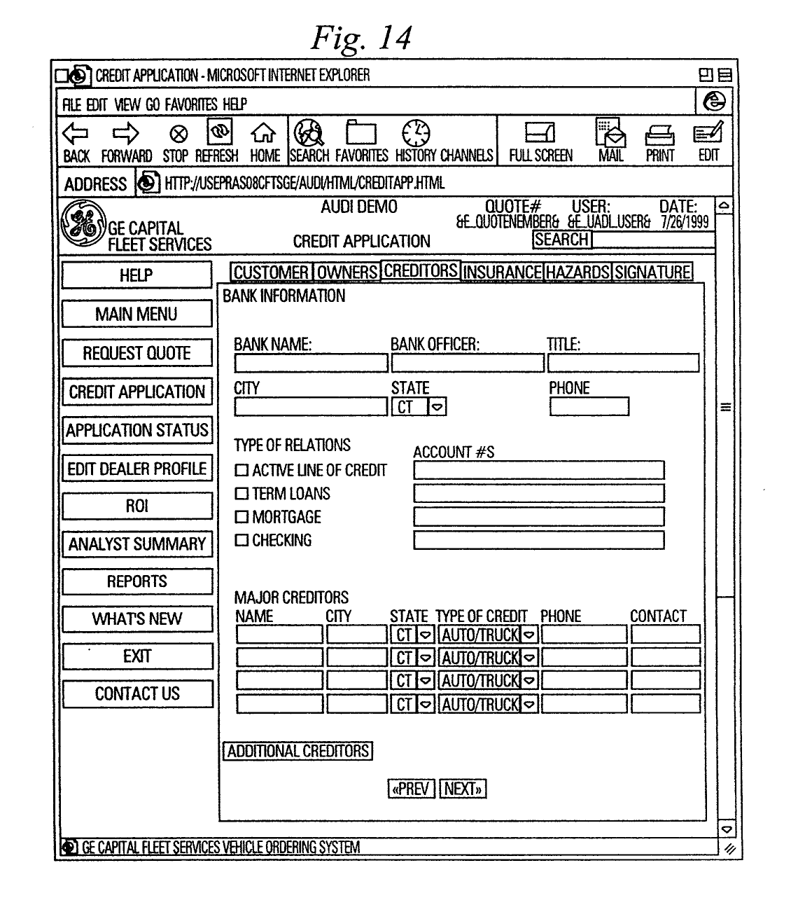

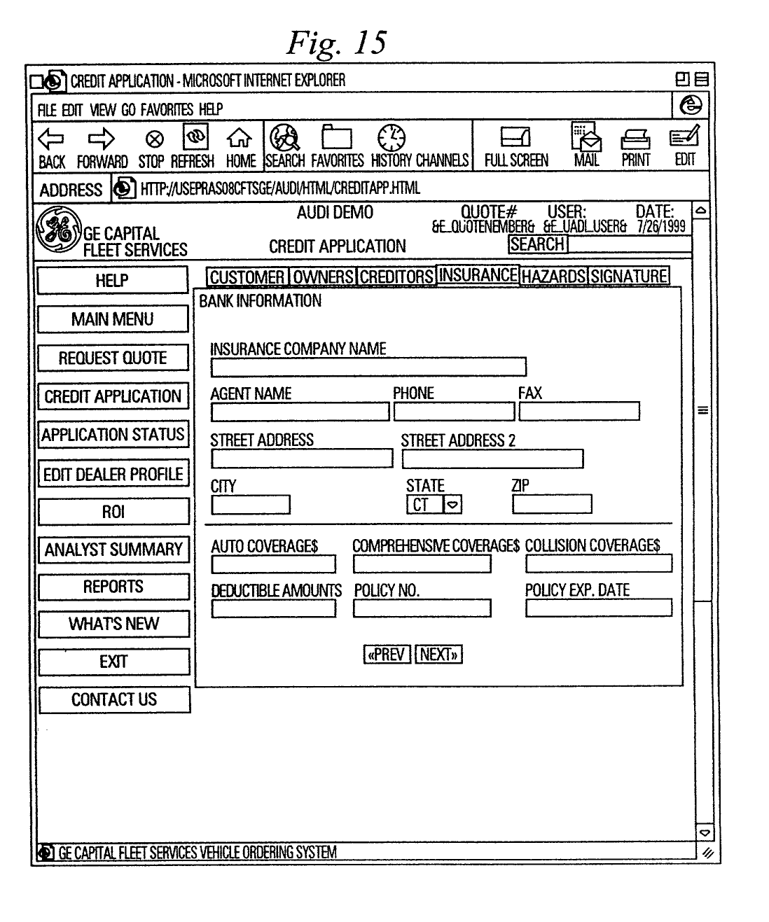

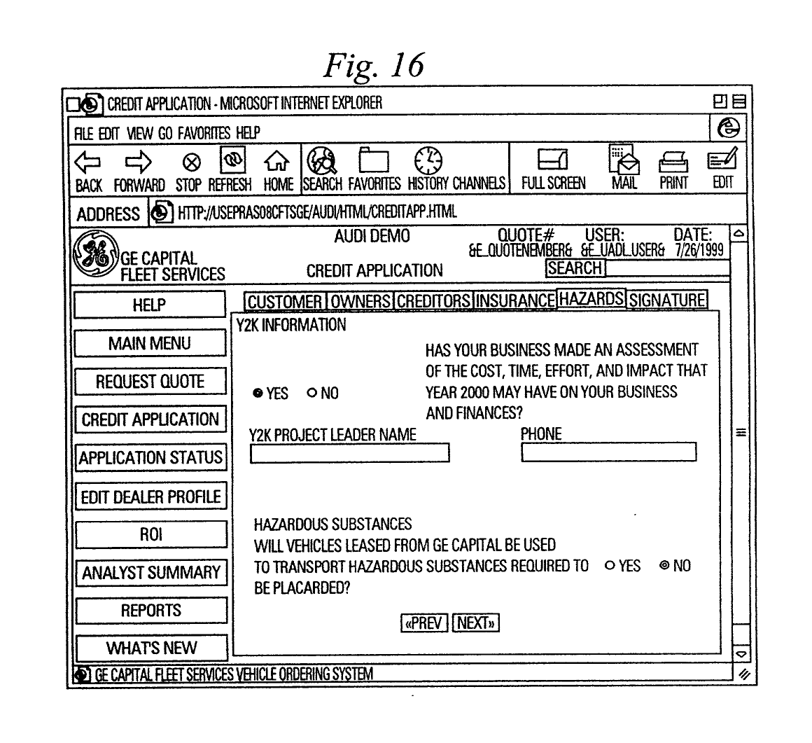

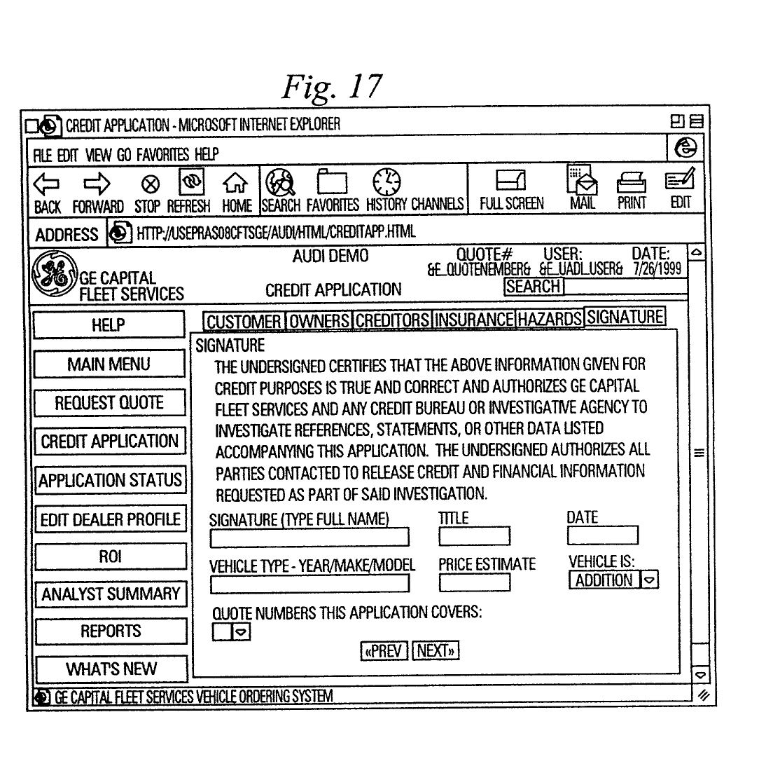

FIGS. 12-17 depict possible web pages that may be presented to the lessee or dealer for entering information about the lessee that may be used for credit scoring. In one embodiment, such information may include personal information about the individual business principal or proprietor, as well as information about the business that will actually make the lease payments for the vehicle. In such an embodiment, the credit of both the business and the individual business owner, principal, or proprietor may be checked through the system and method of the invention. Collateral checks may be performed in one embodiment, as well as other credit checks to ensure that the lessee is credit worthy.

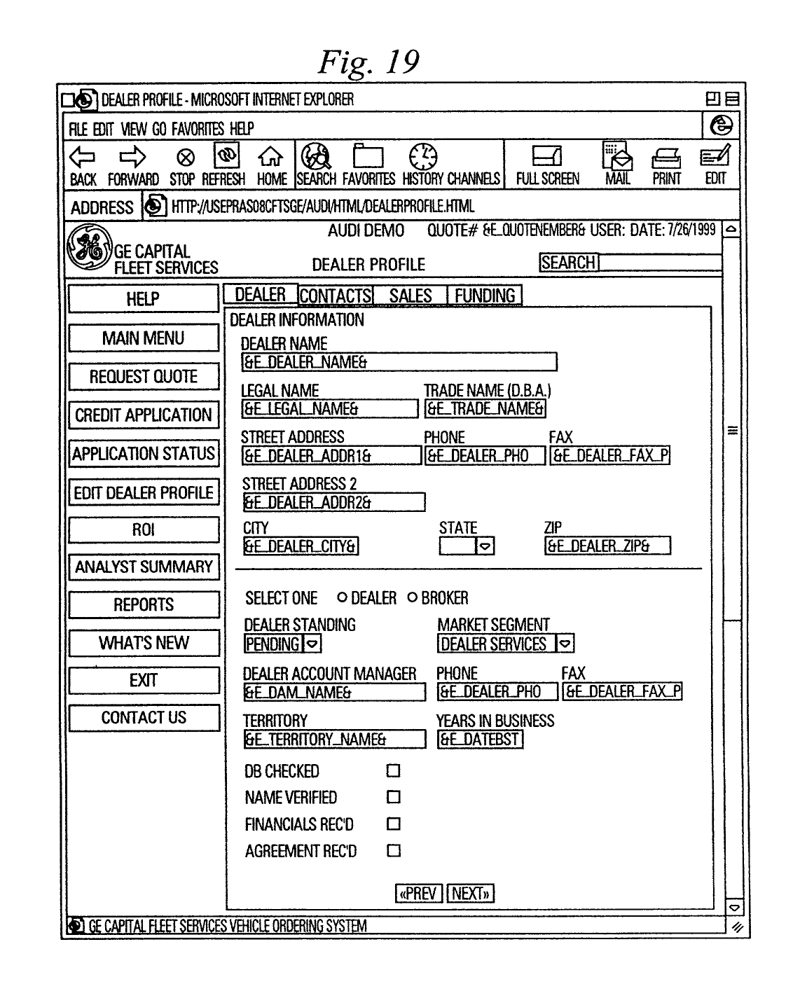

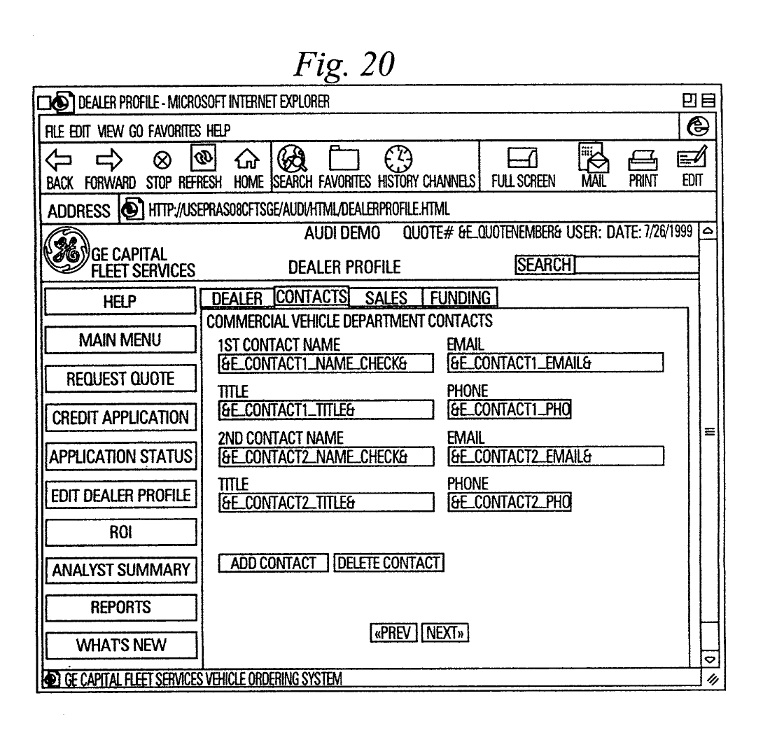

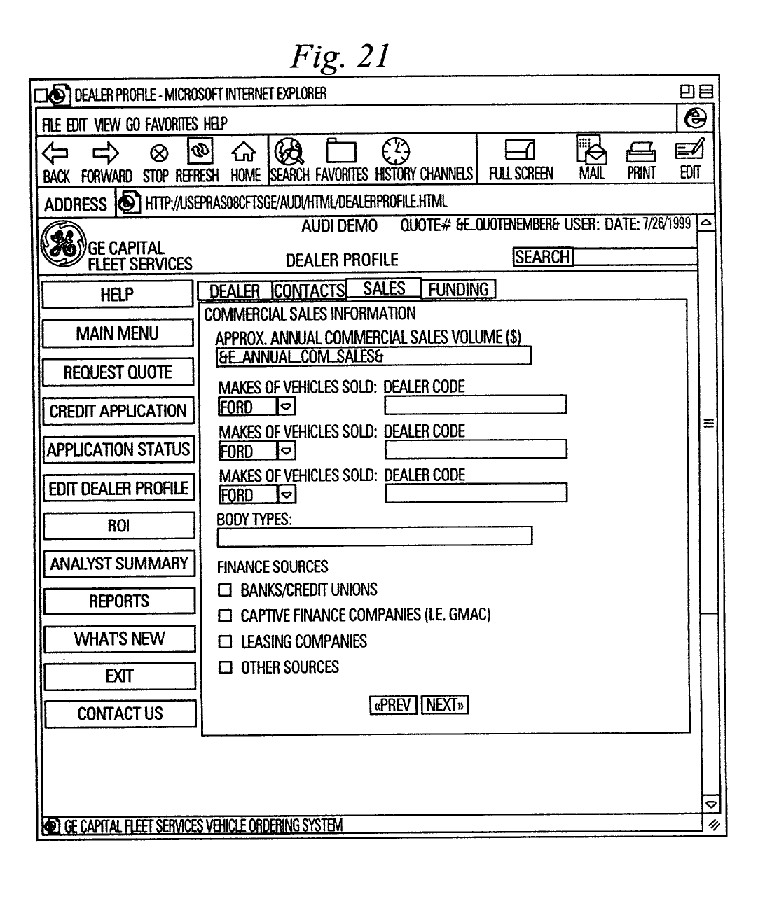

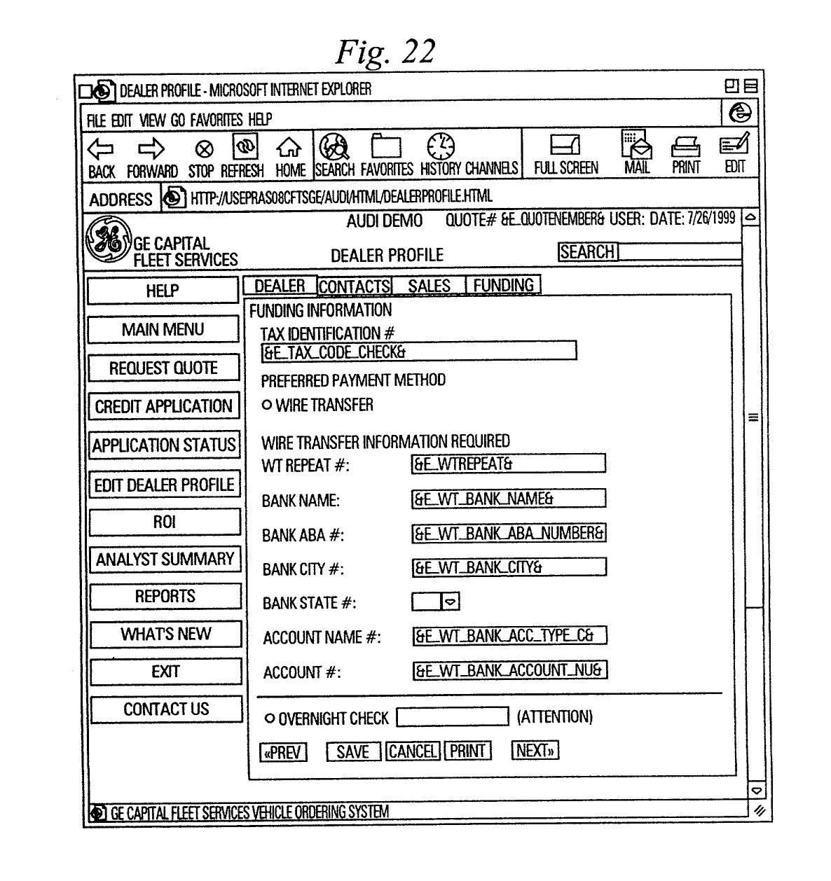

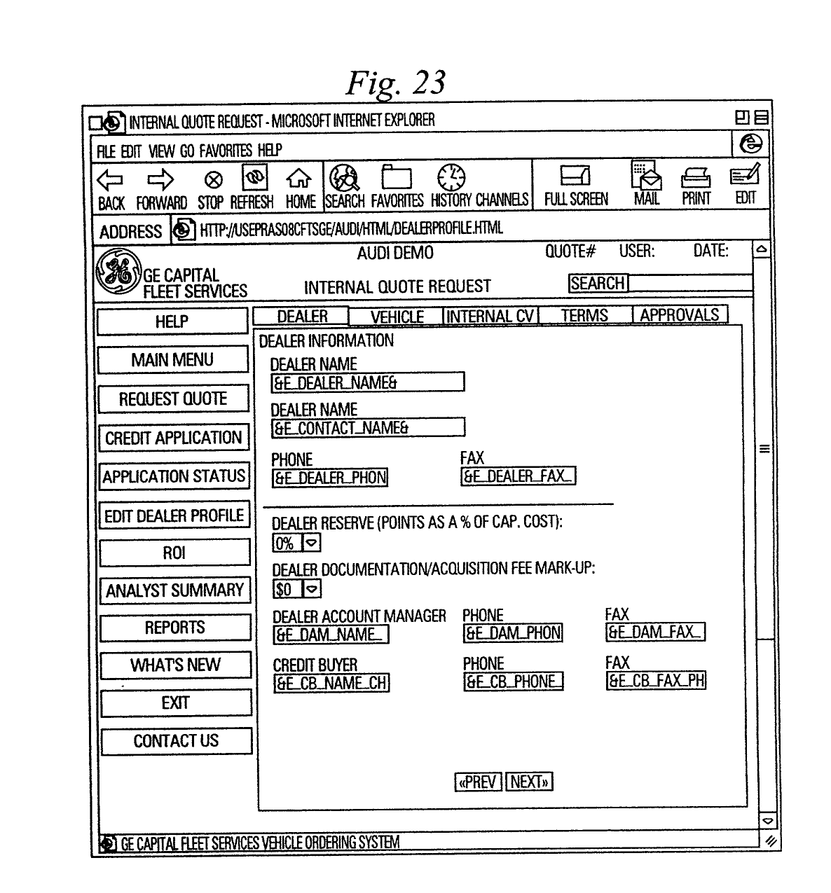

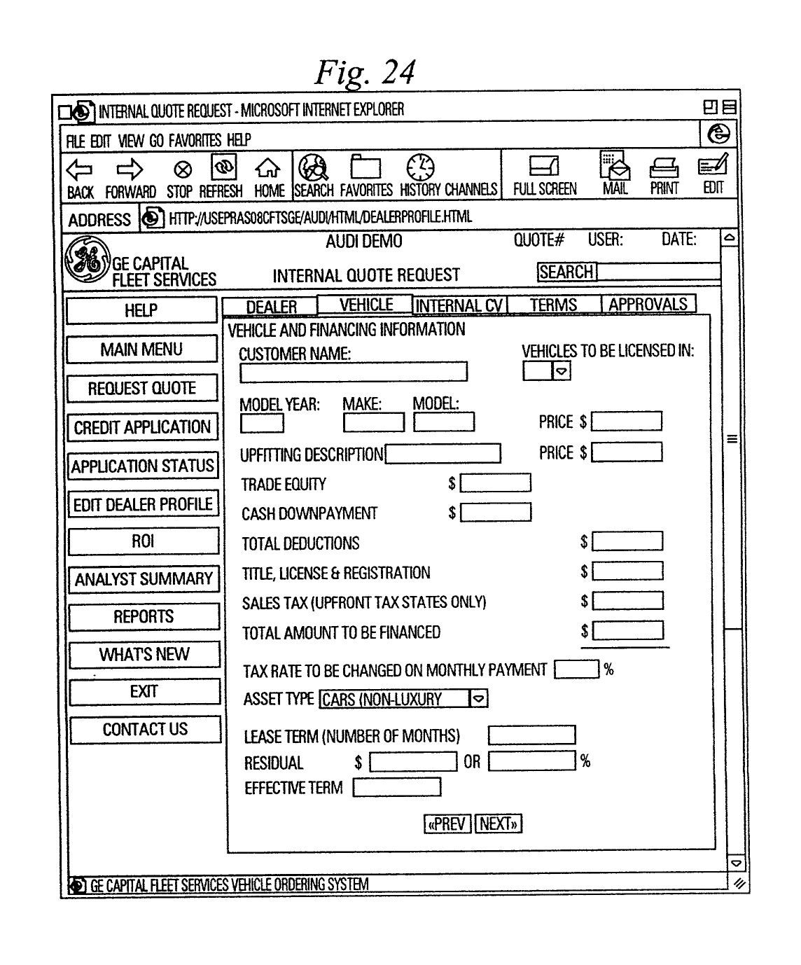

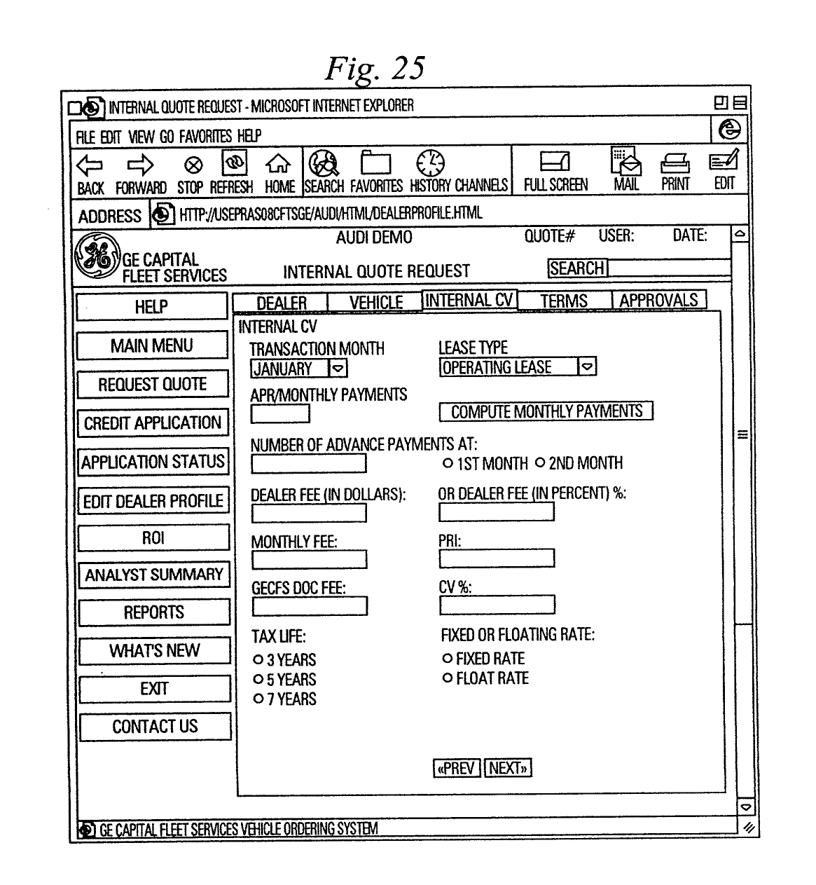

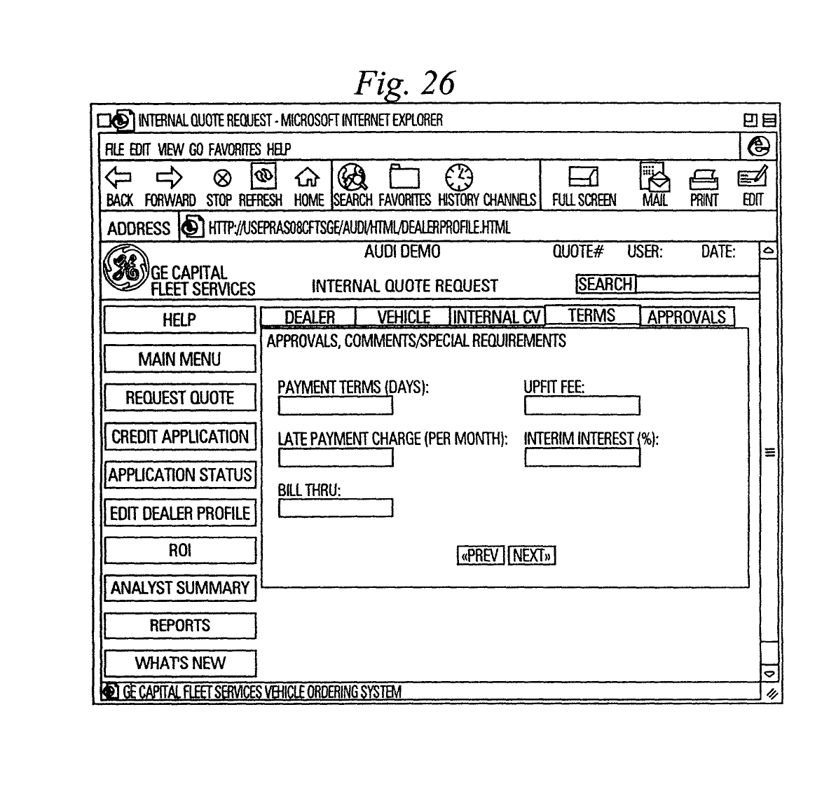

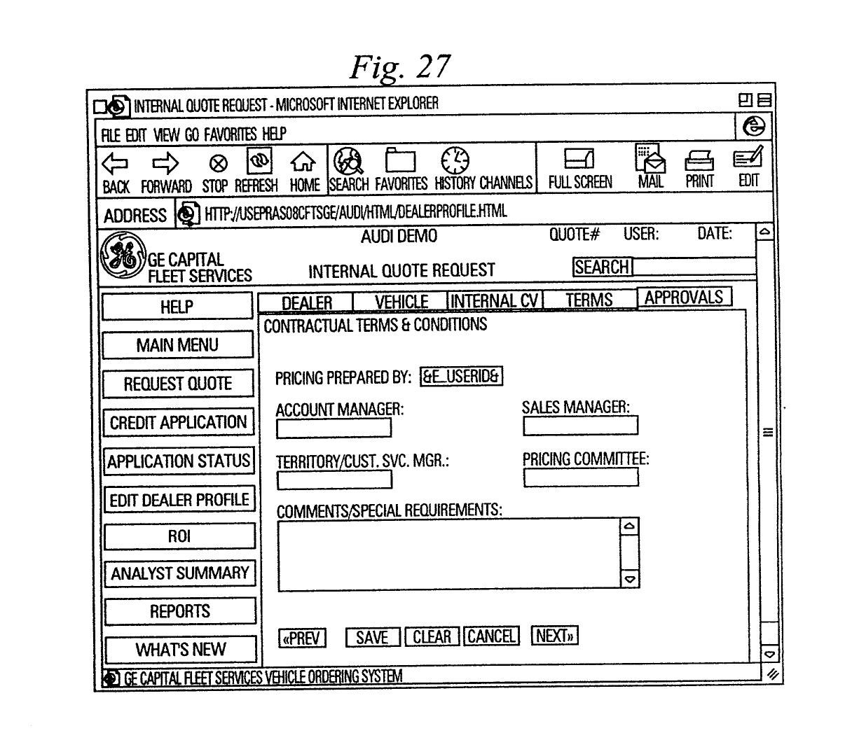

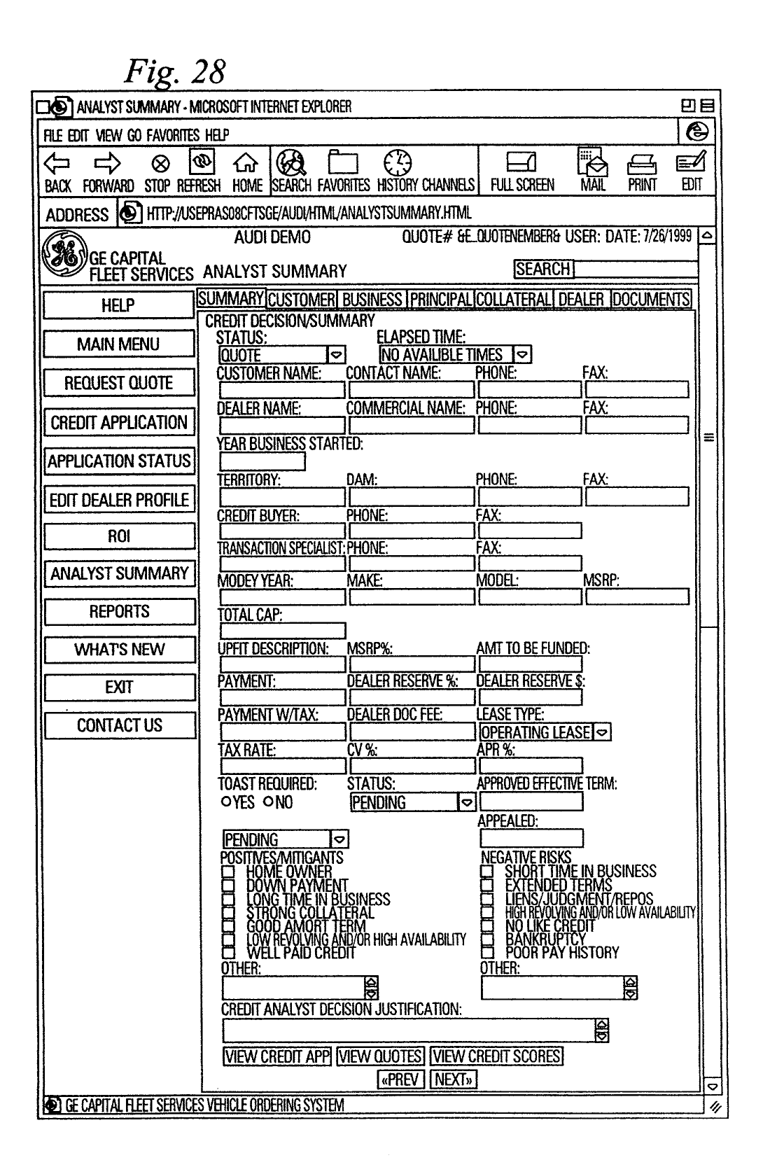

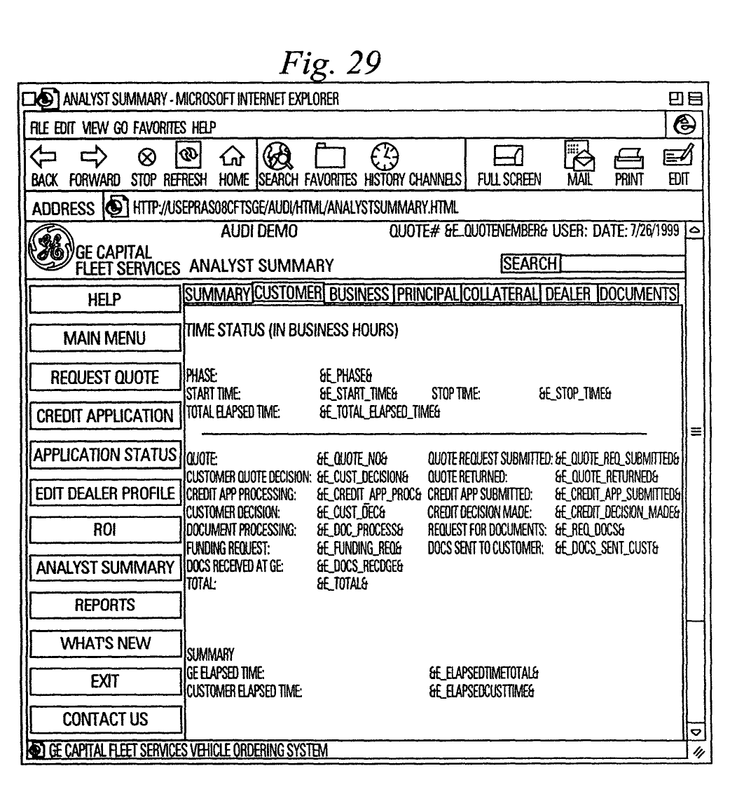

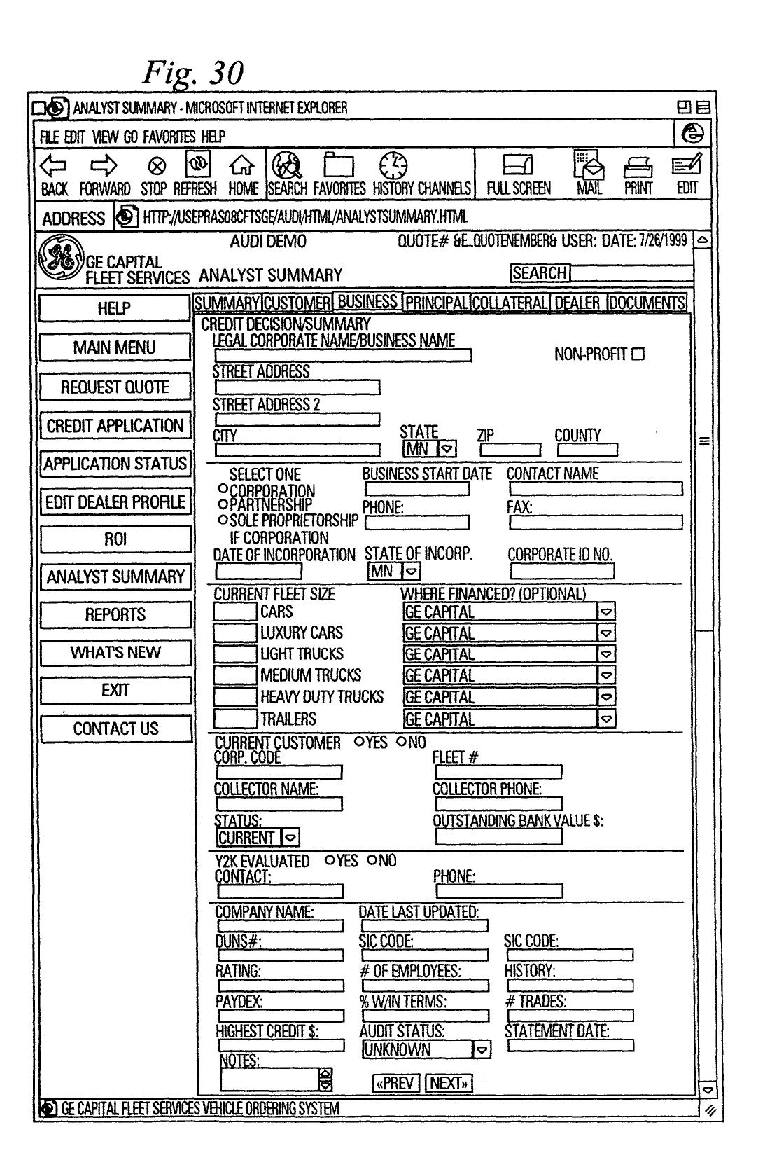

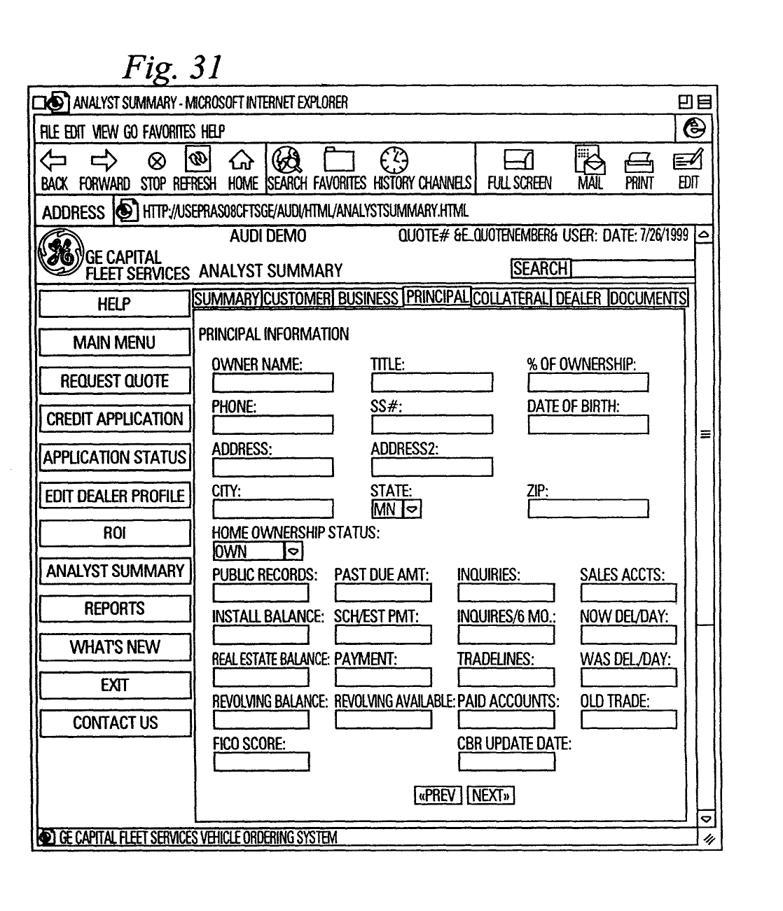

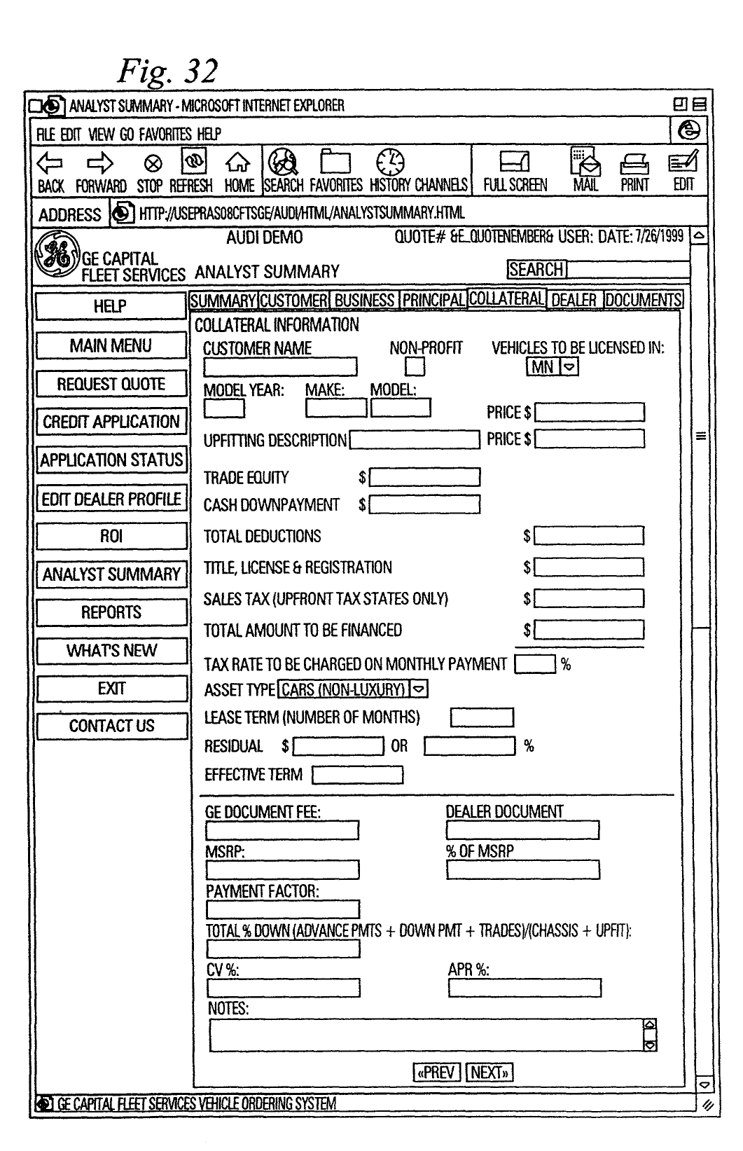

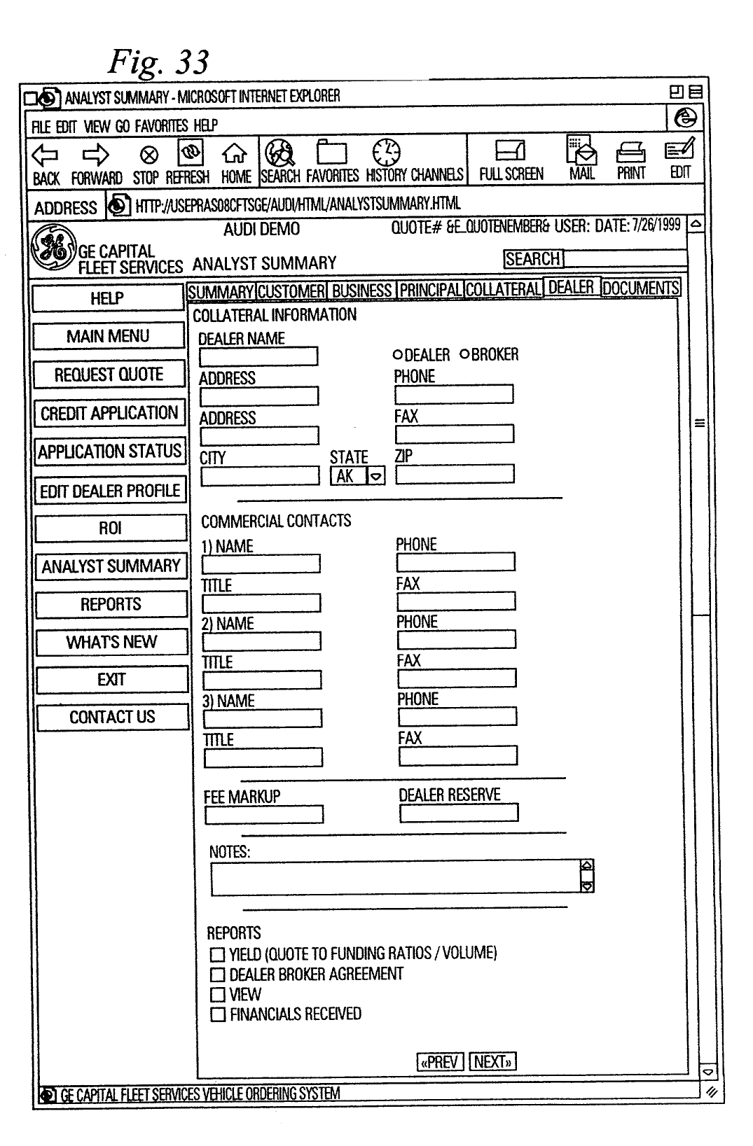

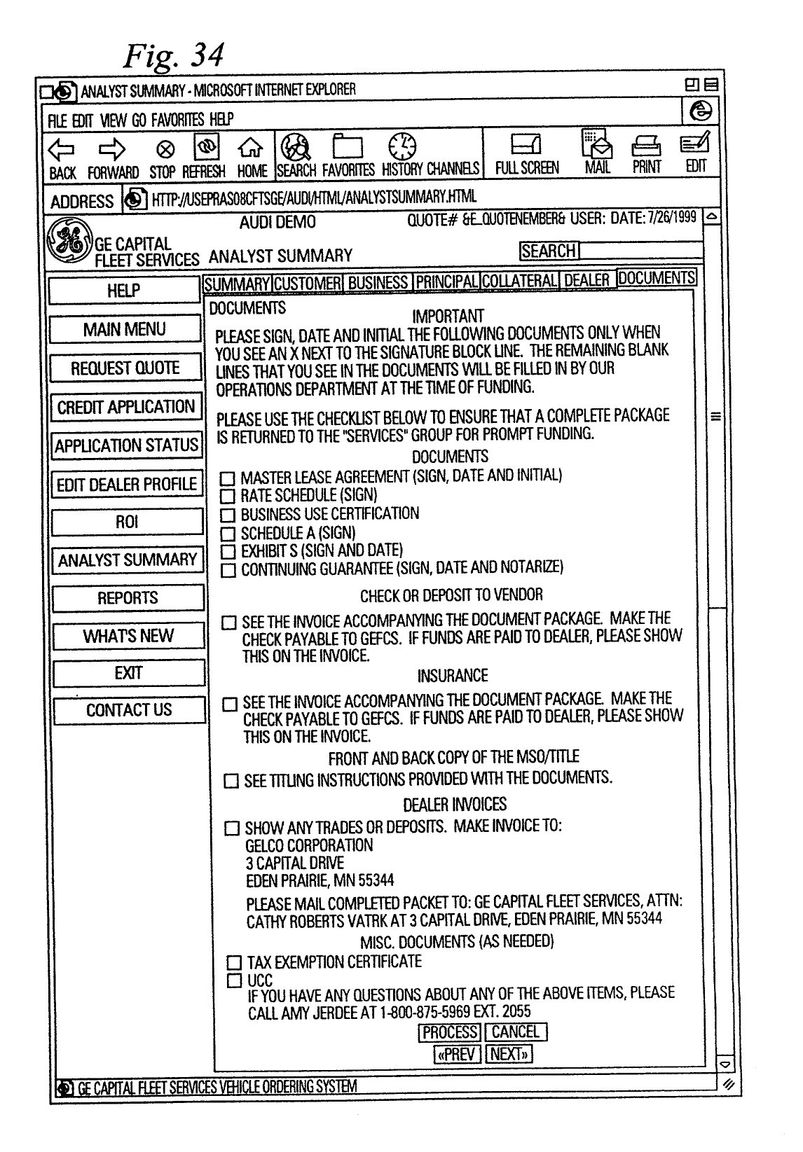

FIGS. 19-22 depict various web pages that an administrator, such as the lessor, may use to review, check, or edit certain information about different dealers. FIGS. 23-34 show various web pages that may be used for internal quote requests and analyst summaries.

In one embodiment of an automated credit scoring system and method of the invention, the server 10 may be capable of automatically connecting to credit scoring services, such as Dun & Bradstreet, as depicted by external sources 20 in FIG. 1. It should be noted that, although some Figures in this specification, such as one or more of FIGS. 3-7, may depict credit scoring that is not automated, credit scoring may be either automated or performed by humans within the scope of the invention. In one embodiment, after credit information is transmitted to the server 10 from the client computer 14, a human can manually perform the credit check at the server level by using outside databases or other information known to those skilled in the art. The human may then transmit a decision on the credit status of the applicant to the client machine 14. In another embodiment, all credit scoring and processing may be accomplished automatically at the server 10 by linking to external credit sources or databases. Commercial credit scoring, including credit scoring for both individuals and companies, may be accomplished using the invention. Humans may also view reports on a credit status and review the source of the credit scoring.

3. Documentation and Other Processes

After a lease quote has been generated and credit approval received, the server 10 may, in one embodiment, automatically generate the documentation to document the lease. FIGS. 3-7 depict a number of the steps of the generation of documentation for a lease transaction using the method and system of the invention.

C. Conclusion

One embodiment of the invention allows a vehicle dealer to enter certain information about the lease of a vehicle in a client computer and then have a quote automatically generated using a client-server system. In addition, the dealer may enter certain credit information about the prospective lessee, and the lessee's credit may be scored for approval or denial automatically over the client-server system. In addition, paperwork to close a lease transaction may be automatically generated upon credit approval. Such paperwork may be available through the client-server system of the invention. Using the method and system of the invention, quotes for vehicle leases may be generated within a matter of minutes or even seconds. In addition, credit scoring may be performed in minutes or seconds, and documenting a lease may be a quick and easy process, rather than a drawn-out process involving numerous facsimiles or mailings.

Appendix A contains further information about the method and system of the invention, including possible web pages that may be used within the scope of the invention for a variety of functions, including those listed above. It should be noted that some of the web pages of the invention may be viewed only by internal personnel of the lessor, while other pages may be viewed by both internal personnel of the lessor and by dealers.

While the present invention has been described with reference to several embodiments thereof, those skilled in the art may recognize various changes that may be made without departing from the spirit and scope of the claimed invention. Accordingly, this invention is not limited to what is shown in the drawings and described in the specification. Any number or ordering of the elements in the following claims is merely for convenience and is not intended to suggest that the ordering of the elements of the claims has any particular significance other than that otherwise expressed by the language of the claims.

What is claimed is:

1. An automated method for generating a quote for a piece of leased equipment, the method comprising:
(a) electronically soliciting from a client terms for a lease for the piece of leased equipment, including a cost and residual value for the piece of leased equipment, term for the lease, and down payment information;
(b) electronically receiving and storing in a server the terms for the lease;
(c) computing payment terms for the lease based on the terms of the lease and a desired rate of return for the lease; and
(d) generating a report at the client showing the payment terms for the lease.

2. The method of claim 1 further comprising the act of generating documentation for the piece of leased equipment such that a user may complete the documentation.

3. The method of claim 1 wherein terms for the lease include a capital cost, a residual, a dealer fee, a documentation fee, upfront fees, length of lease in months, and type of asset.

4. The method of claim 3 wherein the act of computing payment terms comprises:
(a) setting parameters including a borrowing interest rate, a lending interest rate, and a payment schedule; and
(b) calculating a net present value calculation, a revenue calculation, an expense calculation, and a contributed value calculation.

5. The method of claim 1 wherein the act of electronically receiving the terms for the lease from the client further comprises electronically receiving the information over the Internet.

6. The method of claim 1 wherein the act of electronically receiving the terms for the lease further comprises receiving the information through an interactive telephone response system.

7. An automated method for leasing a vehicle comprising:
(a) electronically soliciting from a client terms for a vehicle lease, including a cost and residual value for the vehicle, term for the lease, and down payment information;
(b) computing payment terms at a server for the lease based on the terms of the lease and a desired rate of return for the lease;
(c) generating a report at the client showing the payment terms for the lease;
(d) receiving at the server instructions from a client to go forward with the vehicle lease;
(e) electronically soliciting from the lessee at the client basic identification information, including identification information for an individual user of the leased vehicle;
(f) receiving and storing in the server the client basic identification information;
(g) scoring the lessee's credit using external credit checking databases;
(h) providing a credit report to the client detailing a credit score for the lessee; and
(i) generating documentation for the vehicle lease such that the user at the client may complete the documentation.

8. The method of claim 7 wherein the act of electronically receiving the terms for the lease from the client further comprises electronically receiving the information over the Internet.

9. The method of claim 7 wherein the act of electronically receiving the terms for the lease further comprises receiving the information through an interactive telephone response system.

10. An automated system for generating a quote for a piece of leased equipment, the system comprising:
(a) a user interface;
(b) a server adapted to electronically receive terms of a lease from the user interface, store the terms, process the terms, and generate reports; and
(c) a communication path electronically linking the user interface to the server.

11. The system of claim 10 wherein the server is adapted to generate documentation such that a user can complete the documentation.

12. The system of claim 10 further comprising an external server for communication between the user interface and the server.

13. The system of claim 10 wherein the terms of the lease include a cost and residual value for the piece of leased equipment, a term for the lease, and down payment information.

14. An automated system for generating a credit report for a lessee of a piece of leased equipment, the system comprising:
(a) a user interface;
(b) a server adapted to electronically receive identification information from the user interface, store the information, process the information, and generate reports; and
(c) a communication path electronically linking the user interface to the server.

15. The system of claim 14, further comprising an external server for communication between the user interface and the server.

16. The system of claim 14, further comprising a second communication path electronically linking the server to an external data source.

17. An automated system for generating a quote for a piece of leased equipment and generating a credit report for a lessee of the piece of leased equipment, the system comprising:
(a) a user interface;
(b) a server adapted to electronically receive identification information from the user interface, store the information, process the information, and generate reports; and
(c) a communication path electronically linking the user interface to the server.

18. The system of claim 17, further comprising an external server for communication between the user interface and the server.

19. The system of claim 17, further comprising a second communication path electronically linking the server to an external data source.

20. An automated system for leasing a vehicle, the system comprising:
(a) a user interface;
(b) a server having memory and a processor, wherein the processor contains at least one program to perform the following acts:
(i) electronically soliciting at the user interface terms for a vehicle lease,
(ii) computing payment terms at a server for the lease based on the terms of the lease and a desired rate of return for the lease,
(iii) generating a report at the user interface showing the payment terms for the lease,
(iv) receiving instructions from the user interface to go forward with the vehicle lease,
(v) electronically soliciting from a lessee at the user interface identification information, including identification information for an individual user of the leased vehicle,
(vi) receiving and storing in the server the identification information,
(vii) scoring the lessee's credit using external credit checking databases,
(viii) providing a credit report detailing a credit score for the lessee, and
(ix) generating documentation for the vehicle lease such that the user at the user interface may complete the documentation; and
(c) a communication path electronically linking the user interface to the server.

21. The system of claim 20, further comprising an external server for communication between the user interface and the server.

22. The system of claim 20, further comprising a second communication path electronically linking the server to an external data source.
